(19) United States
(12) Patent Application Publication
(10) Pub. No.: US 2024/0130008 A1
(43) Pub. Date: Apr. 18, 2024

(54) PLANAR HEAT-GENERATING ELEMENT AND HOT AIR SUPPLY APPARATUS

(71) Applicant: CANON KABUSHIKI KAISHA, Tokyo (JP)

(72) Inventors: KEISUKE ABE, Kanagawa (JP); KENTO TSUDA, Kanagawa (JP); MASATO MAMISHIN, Tokyo (JP)

(21) Appl. No.: 18/465,304

(22) Filed: Sep. 12, 2023

(30) Foreign Application Priority Data
Sep. 30, 2022 (JP) 2022-158806
Sep. 30, 2022 (JP) 2022-158808
Oct. 13, 2022 (JP) 2022-164898

(51) Int. Cl. H05B 3/26; H05B 3/03

(52) U.S. Cl. CPC H05B 3/267; H05B 3/03; H05B 2203/022

(57) ABSTRACT

The planar heat-generating element includes: a base material; a heat-generating layer formed on the base material, the heat-generating layer having conductivity; a pair of electrodes arranged to be brought into contact with the heat-generating layer; and a protective layer, wherein the pair of electrodes are arranged so as to be opposed to each other in a direction parallel to a first direction, wherein the heat-generating layer has a plurality of holes in a region between the pair of electrodes, wherein, when widths of two holes out of the plurality of holes in a second direction orthogonal to the first direction, the two holes being present adjacent to each other on one and the same straight line parallel to the second direction and an interval between the two holes in a direction parallel to the second direction satisfy a specific relationship.

### BACKGROUND OF THE INVENTION

### Field of the Invention

The present invention relates to a planar heat-generating element, a hot air supply apparatus, and an inkjet printer. In particular, the planar heat-generating element according to the present invention is applicable to, for example, a hot air heater for drying an ink to be used in an inkjet printer, a heater to be used for drying, heat treatment, firing, or the like in an industrial application, and a heater to be used in an application such as space heating, melting of snow, or freezing prevention.

### Description of the Related Art

Hitherto, as a planar heat-generating element, there has been known one having a structure in which: a resistance heating wire made of nichrome, iron, aluminum, or the like is used as a heat-generating element; a pair of electrodes is arranged at both ends of the heat-generating element; and the heat-generating element and the electrodes are covered with an electrically insulating material such as a rubber sheet. Energization from the electrodes causes a current to flow through the heat-generating element, resulting in an increase in temperature of the heat-generating element through resistance heating. The planar heat-generating element is used in an application where an object is heated with the heat thus generated.

The planar heat-generating element having the above-mentioned structure uses a linear heat-generating source, and hence its heat-generating area is limited, leading to the occurrence of temperature unevenness due to a wiring pattern of the resistance heating wire.

As a planar heat-generating element having a different kind of heat-generating source, there is known one having a heat-generating layer formed in a planar shape by, for example, impregnating an electrically insulating base material, such as a glass cloth or a polymer film, with a metal-based or non-metal-based conductive material, or applying or printing the conductive material onto the base material. The planar heat-generating element using such heat-generating layer has a wide heat-generating area, and hence is advantageous for achieving a uniform temperature distribution.

In order to allow the planar heat-generating element having such planar heat-generating layer to act effectively, it is required that its contact surface with a heating object be stably secured. Accordingly, the heat-generating layer sometimes needs to have formed therein a non-heat-generating region of a specific shape, that is, a hole for the purpose of arranging a fixing member, such as a screw or an adhesive, or the purpose of heating the heating object in accordance with its form or shape.

In Japanese Patent Application Laid-Open No. 2004-79459, there is a proposal of a planar heat-generating element using a rectangular conductive film formed of conductive powder and a binder resin as a heat-generating layer, on which electrodes and an electrically insulating protective layer are arranged, the planar heat-generating element having through-holes for firmly fixing the planar heat-generating element with a fixing member. In addition, the heat-generating layer of the planar heat-generating element described in Japanese Patent Application Laid-Open No. 2004-79459 has formed therein, for example, circular holes.

In addition, in Japanese Patent Publication No. S59-14234, there is a proposal of a planar heat-generating element (electric heat-generating element for a hot air machine) obtained by laminating a plurality of unit heat-generating plates each obtained by arranging a resistor film and electrodes on a substrate having formed therein a large number of through-holes for forming air passages. In addition, the heat-generating layer of the planar heat-generating element described in Japanese Patent Publication No. S59-14234 has formed therein circular holes.

However, each of the planar heat-generating elements described in Japanese Patent Application Laid-Open No. 2004-79459 and Japanese Patent Publication No. S59-14234 sometimes underwent the occurrence of temperature unevenness in the plane of its heating surface. In addition, the planar heat-generating element of Japanese Patent Publication No. S59-14234 has a configuration in which a plurality of heat-generating layers are laminated in order to increase the efficiency of hot air generation, and still has a problem in that the multilayering of the heat-generating layers increases power consumption.

Further, in Japanese Patent Application Laid-Open No. 2007-109640, a conductive composition formed of conductive powder and a polyimide precursor is applied to the surface of an insulating base layer. Then, the conductive composition is dried at a temperature of from 80° C. to 120° C., and then increased in temperature to 200° C. and maintained at this temperature. After that, the conductive composition is gradually increased in temperature from 250° C. to 400° C., and maintained at this temperature to complete its imidation, to thereby form a heat-generating layer on the insulating base layer. Then, electrodes for power supply are arranged on the heat-generating layer through use of a conductive coating material such as a silver paste, or metal foil, a metal mesh, or the like. Further, a polyimide precursor solution is applied to the surfaces thereof, and its imidation is completed to form an insulating layer. Thus, a planar heat-generating element is completed.

Accordingly, in view of the above-mentioned problems, an object of the present invention is to provide a planar heat-generating element having holes in its heat-generating layer, the planar heat-generating element having reduced temperature unevenness in the plane of its heating surface.

### SUMMARY OF THE INVENTION

According to one aspect of the present invention, there is provided a planar heat-generating element including: a base material; a heat-generating layer formed on the base material, the heat-generating layer having conductivity; a pair of electrodes arranged to be brought into contact with the heat-generating layer; and a protective layer covering at least part of each of the pair of electrodes and the heat-generating layer, wherein the pair of electrodes are arranged so as to be opposed to each other in a direction parallel to a first direction, wherein the heat-generating layer has a plurality of holes in a region between the pair of electrodes, wherein the base material and the protective layer each have holes to be connected to the holes of the heat-generating layer at positions corresponding to the holes of the heat-generating layer, and wherein, when widths of two holes out of the plurality of holes in a second direction orthogonal to the first direction, the two holes being present adjacent to each other on one and the same straight line parallel to the second direction, are represented by a1 and a2, respectively, and an interval between the two holes in a direction parallel to the second direction is represented by D, the D, the a1, and the a2 satisfy a relationship represented by the following expression (1).

2×(a1+a2)/2<D<10×(a1+a2)/2 (1)

In addition, according to another aspect of the present invention, there is provided a planar heat-generating element including: a base material; a heat-generating layer arranged on the base material; electrodes to be brought into contact with the heat-generating layer; and a protective layer covering the electrodes and the heat-generating layer, the planar heat-generating element having one or more through-holes penetrating through the base material, the heat-generating layer, and the protective layer, wherein a through-hole adjacent portion of the heat-generating layer is thicker, or has a lower volume resistivity, than another portion of the heat-generating layer.

In addition, according to another aspect of the present invention, there is provided a planar heat-generating element including: a base material; a heat-generating layer arranged on the base material; electrodes arranged to be brought into contact with the heat-generating layer; and a protective layer covering at least part of each of the electrodes and the heat-generating layer, wherein the base material and the protective layer are each formed of polyimide, and wherein an imidation ratio of the polyimide of the protective layer is smaller than an imidation ratio of the polyimide of the base material.

In addition, according to another aspect of the present invention, there is provided a hot air supply apparatus including: the above-mentioned planar heat-generating element; and an air blower configured to generate an air flow.

In addition, according to another aspect of the present invention, there is provided an inkjet printer including the above-mentioned hot air supply apparatus.

Further features of the present invention will become apparent from the following description of exemplary embodiments with reference to the attached drawings.

### BRIEF DESCRIPTION OF THE DRAWINGS

FIG. 1 is a top schematic view for illustrating a planar heat-generating element according to a first embodiment.

FIG. 2 is a cross-sectional schematic view for illustrating the planar heat-generating element according to the first embodiment.

FIG. 3 is a top schematic view for illustrating the planar heat-generating element according to the first embodiment.

FIG. 4 is a top schematic view for illustrating the planar heat-generating element according to the first embodiment.

FIG. 5A, FIG. 5B, FIG. 5C, and FIG. 5D are schematic views for illustrating the influence of a relationship between the widths of holes of a heat-generating layer and the interval between the holes on the flow of currents.

FIG. 6 is a graph showing an example of results of evaluation of temperature unevenness in the vicinity of holes with varying diameters of the openings of the holes.

FIG. 7 is a schematic view of a hot air supply apparatus according to the present invention.

FIG. 8 is a schematic view of an inkjet printer according to the present invention.

FIG. 9 is a view for illustrating the arrangement and shape of holes of a heat-generating layer in a planar heat-generating element according to one of Examples.

FIG. 10 is a view for illustrating the arrangement and shape of holes of a heat-generating layer in a planar heat-generating element according to one of Examples.

FIG. 11 is a view for illustrating the arrangement and shape of holes of a heat-generating layer in a planar heat-generating element according to one of Examples.

FIG. 12 is a view for illustrating the arrangement and shape of holes of a heat-generating layer in a planar heat-generating element according to one of Examples.

FIG. 13 is a view for illustrating the arrangement and shape of holes of a heat-generating layer in a planar heat-generating element according to one of Examples.

FIG. 14 is a view for illustrating the arrangement and shape of holes of a heat-generating layer in a planar heat-generating element according to one of Examples.

FIG. 15 is a view for illustrating the arrangement and shape of holes of a heat-generating layer in a planar heat-generating element according to one of Examples.

FIG. 16 is a view for illustrating the arrangement and shape of holes of a heat-generating layer in a planar heat-generating element according to one of Examples.

FIG. 17A and FIG. 17B are top views of an example of a planar heat-generating element according to a second embodiment.

FIG. 18 is a cross-sectional view of an example of the planar heat-generating element according to the second embodiment.

FIG. 19 is a flow chart for illustrating one embodiment of a method of manufacturing the planar heat-generating element according to the second embodiment.

FIG. 20 is a cross-sectional schematic view of a planar heat-generating element in Example 3A of the second embodiment.

FIG. 21 is a cross-sectional schematic view of a planar heat-generating element in Example 5A of the second embodiment.

FIG. 22 is a cross-sectional schematic view of a planar heat-generating element in Comparative Example 1A of the second embodiment.

FIG. 23 is a top schematic view for illustrating an example of a planar heat-generating element according to a third embodiment.

FIG. 24 is a cross-sectional schematic view for illustrating an example of the planar heat-generating element according to the third embodiment.

FIG. 25A is a top view for illustrating the definitions of the warping and curvature of the planar heat-generating element according to the third embodiment.

FIG. 25B is a plan view for illustrating the definitions of the warping and curvature of the planar heat-generating element according to the third embodiment.

### DESCRIPTION OF THE EMBODIMENTS

### First Embodiment

Exemplary embodiments of the present invention are described in detail below with reference to the drawings. However, the sizes, materials, and shapes of components described in the following embodiments, their relative arrangement, and the like are subject to appropriate modification in accordance with the configuration of an apparatus to which the present invention is applied, and various conditions. Accordingly, it is not intended to limit the scope of the present invention only to those embodiments.

In each of the planar heat-generating elements described in Japanese Patent Application Laid-Open No. 2004-79459 and Japanese Patent Publication No. S59-14234, the heat-generating layer formed in a planar shape has holes. Accordingly, a current that flows through the heat-generating layer at the time of energization detours around the holes, and thus a variation in current density occurs to produce unevenness in resistance heating. As a result, temperature unevenness occurs in the vicinity of the holes. This phenomenon leads to temperature unevenness of a heating object, possibly causing a reduction in quality or a defect. In addition, breakage of the planar heat-generating element itself or thermal deterioration of its material is sometimes induced at an excessive temperature increase portion of the temperature unevenness. In addition, a local temperature difference is produced in the planar heat-generating element to cause distortion thereof or peeling of a fixed portion, with the result that the object cannot be uniformly heated in some cases.

The inventors have made extensive investigations, and as a result, have found that the above-mentioned problem in the related art can be solved by using a planar heat-generating element according to the present invention described below.

### (Configuration of Planar Heat-Generating Element)

A planar heat-generating element according to one embodiment of the present invention is described.

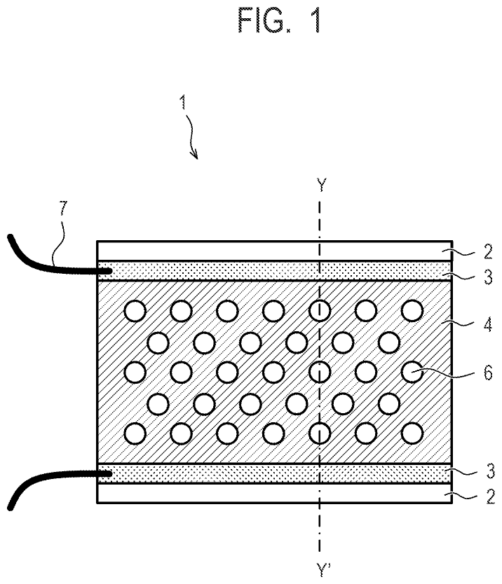

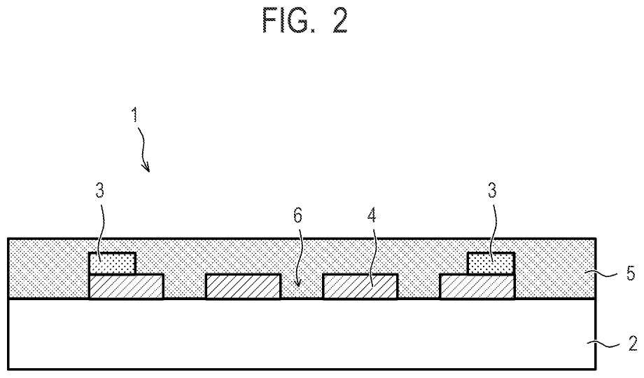

FIG. 1 is a top schematic view of a planar heat-generating element 1 according to one embodiment of the present invention, and FIG. 2 is a cross-sectional schematic view taken along the line Y-Y′ of FIG. 1.

The planar heat-generating element 1 includes: a base material 2; a heat-generating layer 4 formed on the base material 2, the layer having conductivity; a pair of electrodes 3 arranged to be brought into contact with the heat-generating layer 4; and a protective layer 5 covering at least part of each of the pair of electrodes 3 and the heat-generating layer 4. In this case, the pair of electrodes 3 are arranged so as to be opposed to each other in a direction parallel to the first direction.

In the present invention, the first direction is a direction in which the pair of electrodes 3 are opposed to each other, that is, a direction going from one of the electrodes toward the other electrode, and more strictly, is a direction parallel to a straight line connecting the respective centers of gravity of the two electrodes. In addition, a second direction is a direction orthogonal to the above-mentioned first direction on a plane in a direction in which the heat-generating layer 4 extends (direction orthogonal to a direction in which the base material 2 and the heat-generating layer 4 are laminated).

The base material 2 is, for example, an electrically insulating member formed of polyester, polyimide, or the like.

In addition, the heat-generating layer 4 may be formed by, for example, forming a conductive paste containing conductive powder, a binder resin, and a solvent as components into a film on the base material 2 through use of a bar coater, an applicator, screen printing, or the like, and drying the film. The heat-generating layer 4 has a plurality of holes 6 in a region between the pair of electrodes, the holes being formed by a method involving, for example, performing the patterning of hole shapes at the time of the film formation from the conductive paste, or forming through-holes after the film formation through use of, for example, a drill, a laser, or a punching die.

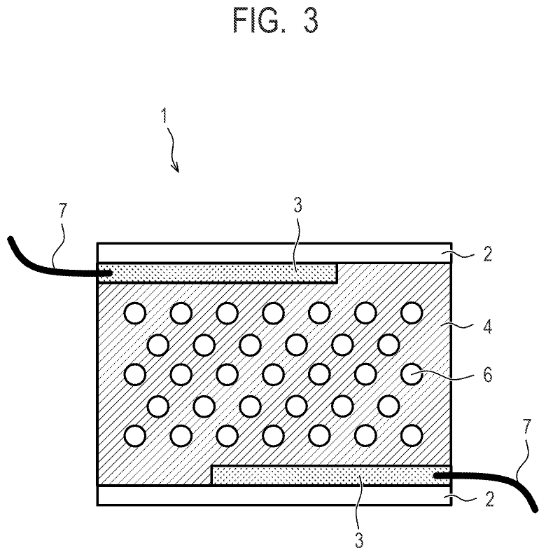

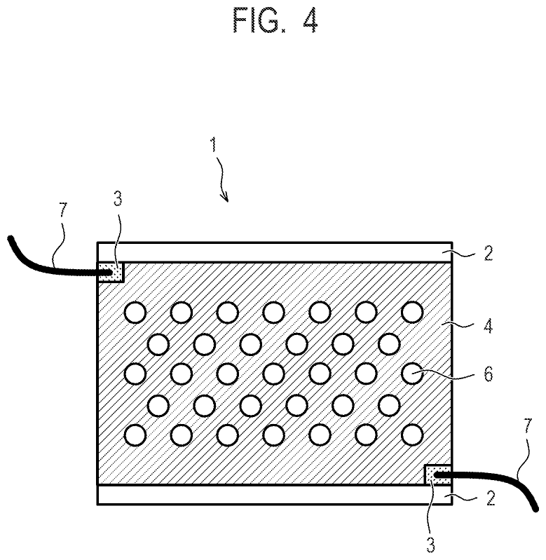

In the planar heat-generating element 1, the electrodes 3 are formed at edge portions forming two sides opposed to each other on the heat-generating layer 4 through use of a material having lower resistance than the heat-generating layer 4, such as a paste or foil of silver or copper. The electrodes 3 may be, as illustrated in FIG. 3, arranged on parts of two sides of a rectangular heat-generating layer 4 facing each other. The configuration illustrated in FIG. 3 is a configuration that may be adopted when the pairs of electrodes 3 are arranged alternately like comb teeth. In addition, the electrodes 3 may be, as illustrated in FIG. 4, arranged on corners of the rectangular heat-generating layer 4 facing each other. Electric wires 7 for allowing a current to flow from an external power source are connected to the electrodes 3.

The protective layer 5 may be, for example, arranged so as to cover the electrodes 3 and the heat-generating layer 4, and to maintain a state in which the heat-generating layer 4 adheres to the base material 2, by applying and drying an insulating material, such as polyamide-imide, polyimide, a silicone, or an epoxy.

Next, details about the properties of each layer of the planar heat-generating element 1 and a manufacturing process thereof are described.

### (Base Material 2)

Abase material having a shape such as a sheet shape or a plate shape may be used as the base material 2. A material having an electrical insulating property and heat resistance, and preferably further having incombustibility or flame retardancy may be used as a material for the base material 2. Specifically, the base material 2 is, for example, a resin film formed of a polyester resin, a phenol resin, an epoxy resin, a polyimide resin, a polyamide resin, or any other fiber reinforced plastic (FRP). In addition, for example, a resin sheet formed of a fluororesin, such as polyvinyl fluoride, polyvinylidene fluoride, polytetrafluoroethylene, or an ethylene-tetrafluoroethylene copolymer, or a rubber sheet formed of a rubber, such as a silicone rubber, a fluororubber, a urethane rubber, a styrene butadiene rubber (SBR), an ethylene propylene diene rubber (EPDM), a nitrile butadiene rubber (NBR), a chlorinated polyethylene rubber (CPE), or a thermoplastic elastomer (TPE), may also be used as the base material 2. In addition, a flame retardant nonwoven fabric or woven fabric (e.g., one formed of a fiber of glass, asbestos, or quartz), a vinyl chloride resin sheet, or the like may also be used as the base material 2. In addition, a metal plate of SUS, aluminum, or the like having a surface given insulation protection with a resin coat or an illumination may also be used as the base material 2.

The thickness of the base material 2 is not particularly limited, but is, for example, from about 20 μm to about 300 μm.

### (Heat-Generating Layer 4)

The heat-generating layer 4 may be formed by applying or printing a conductive paste into a sheet shape. The conductive paste preferably contains conductive powder, a binder resin, and a solvent. That is, the heat-generating layer 4 is preferably formed of a binder resin containing conductive powder. Commercially available examples of the conductive paste include a carbon paste DY-150H-30 manufactured by Toyobo Co., Ltd. and a carbon paste JELCON CH-8 manufactured by Jujo Chemical Co., Ltd. The conductive paste for forming the heat-generating layer 4 may also be prepared by using and appropriately blending an appropriate combination of materials for the conductive powder, the binder resin, and the solvent. The volume resistivity of the conductive paste is preferably 1.0×10⁻¹ Ω·cm or less from the viewpoint of a heat-generating characteristic. In addition, the volume resistivity is preferably 1.0×10⁻³ Ω·cm or more from the viewpoint of the heat resistance of the conductive paste itself.

For example, carbon black, graphite, or particles or scaly foil pieces of a metal or metal oxide having conductivity, such as iron, copper, silver, nickel, or indium tin oxide (ITO), may be used as the conductive powder. Of those, carbon black or graphite, which is inexpensive, is preferred as the conductive powder. Commercially available examples of the carbon black include KETJEN BLACK EC300J, CARBON ECP, KETJEN BLACK EC600JD, CARBON ECP600JD, and LIONITE CB manufactured by Lion Specialty Chemicals Co., Ltd. Commercially available examples of the graphite include J-CPB, MCP-10, MCP-15, CPB, CB-150, FB-150, CB-100, FB-100, F#1, F#2, and F#3 manufactured by Nippon Graphite Industries, Co., Ltd. In addition, those conductive powders may be used alone or in combination thereof.

The binder resin is, for example, a resin paste of an ethylene-vinyl acetate copolymer, an acrylic resin, a silicone resin, a polyimide resin, a polyester resin, or a polyamide resin. Of those, a polyimide resin paste, which is excellent in heat resistance, is preferred as the binder resin. Commercially available examples of the polyimide resin paste include U-Varnish-A and U-Varnish-S manufactured by Ube Industries, Ltd., and U-Imide Varnish AR, U-Imide Varnish AH, U-Imide Varnish BH, U-Imide Varnish C, U-Imide Varnish CR, and U-Imide Varnish CH manufactured by Unitika Ltd. In addition, those resin pastes may be used alone or in combination thereof.

The solvent is not particularly limited as long as the solvent can dissolve the binder resin. In particular, the solvent is preferably a high-boiling-point solvent, such as toluene, ethylene glycol, ethylene glycol monoether, or N-methyl-2-pyrrolidone (NMP), which hardly evaporates at the time of printing. Those solvents may be used alone or in combination thereof.

The conductive paste may be produced by mixing the above-mentioned blending materials with their blending ratio appropriately adjusted to achieve a desired volume resistivity and thickness of the film formed. A method for the mixing of the blending materials for the conductive paste is not particularly limited, but examples thereof include methods using a triple roll mill, a kneader, a planetary mixer, and a stirring machine. Of those, a triple roll mill, which can finely pulverize aggregates of the conductive powder at the time of the mixing, is preferred.

A method of forming the heat-generating layer 4 is not particularly limited, but examples thereof include an applicator, a bar coater, screen printing, silk screen printing, gravure printing, flexographic printing, offset printing, and roll transfer printing. Of those, screen printing, silk screen printing, gravure printing, flexographic printing, offset printing, or roll transfer printing, which enables the formation of the heat-generating layer 4 in a desired pattern on the base material 2, is preferred. Non-printed portions to be formed in the heat-generating layer 4, i.e., the holes are separately described below. The thickness of the heat-generating layer 4 may be freely changed in accordance with the volume resistivity of the conductive paste, and may be set to, for example, from about 1 μm to about 1,000 μm. The thickness of the heat-generating layer 4 is preferably 30 μm or less from the viewpoint of deformation of the base material 2 due to curing shrinkage of the conductive paste.

### (Holes 6 of Heat-Generating Layer 4)

The holes 6 of the heat-generating layer 4, that is, portions where the conductive paste is not printed are formed for: through-holes for passage of air, for allowing the planar heat-generating element 1 to be used for hot air generation; the arrangement of a member for fixing the planar heat-generating element 1; or the like. These portions are hereinafter referred to as “holes” or “holes of the heat-generating layer.” The holes 6 of the heat-generating layer 4 are preferably arranged in a staggered shape or a lattice shape as seen from a direction parallel to the lamination direction of the base material 2 and the heat-generating layer 4. The opening shape of each of the holes 6 is, for example, an ellipse. In addition, the opening shapes of the holes 6 may include at least one selected from a circle and a polygon, and are not particularly limited.

The ratio of the sum total of the opening areas of the holes 6 to the area of the heat-generating layer 4 preferably falls within the range of from 0.5% or more to 15% or less. The ratio of the sum total of the opening areas of the holes 6 to the area of the heat-generating layer 4 is hereinafter sometimes referred to as “hole area ratio”. When the hole area ratio is 0.5% or more, for example, in the case where through-holes to be described later are formed and the planar heat-generating element 1 is used for hot air generation, a sufficient air volume and air speed can be obtained.

In addition, in the case where the holes 6 are used for fixing the planar heat-generating element 1, when the hole area ratio is 0.5% or more, the planar heat-generating element 1 can be firmly fixed to an object by being caused to sufficiently adhere thereto. A more preferred hole area ratio is 1.2% or more. In addition, when the hole area ratio is 15% or less, the heat-generating layer 4 can obtain a sufficient heat-generating area, and its temperature increase performance with respect to input power can be made sufficiently high.

### (Relationship Between Holes 6 and Temperature Unevenness)

A relationship between the holes 6 of the heat-generating layer 4 and temperature unevenness is described.

With regard to two holes 6 present adjacent to each other on one and the same straight line parallel to the second direction orthogonal to the first direction out of the plurality of holes 6 of the heat-generating layer 4, the widths of the holes 6 and the distance between the two adjacent holes 6 are defined as described below.

The widths of the two adjacent holes 6 in the second direction are represented by a1 and a2, respectively, and the interval between the two adjacent holes 6 in a direction parallel to the second direction is represented by D.

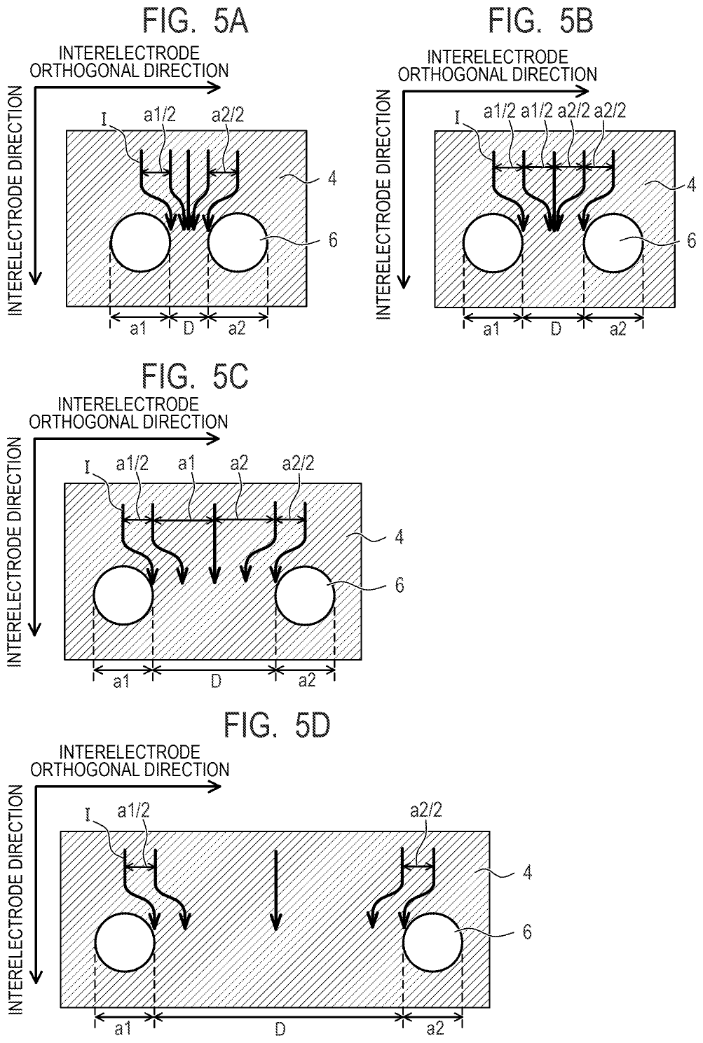

FIG. 5A to FIG. 5D are views for illustrating the influence of a relationship between the widths of the holes 6 and the interval between the adjacent holes 6 on currents I flowing in the heat-generating layer.

When the holes 6 are present in the heat-generating layer 4, the currents I (arrows in FIG. 5A to FIG. 5D) flowing in the direction in which the pair of electrodes face each other (hereinafter sometimes referred to as “interelectrode direction”) (first direction) flow so as to detour around the holes 6. As a result, the currents I flow in a concentrated manner into the gap between the two adjacent holes 6 in the direction orthogonal to the direction in which the pair of electrodes face each other (hereinafter sometimes referred to as “interelectrode orthogonal direction”) (second direction), and hence the current density is increased. Accordingly, resistance heat generation is increased between the two adjacent holes 6. This is the cause of the temperature unevenness in the heat-generating layer 4.

Assumed that, when the currents I flowing in the interelectrode direction reach the holes 6, the currents I that have been flowing so as to pass within the range of the widths of the holes 6 in the interelectrode orthogonal direction are blocked by the holes 6 to be divided into right and left halves and detour therearound. In this case, in the region between the two holes 6, the currents that have flown by detouring around each of the two adjacent holes 6 join together with the current that originally flows into the region.

FIG. 5A is a view for illustrating a case in which the interval D between the two adjacent holes 6 is smaller than the average (a1+a2)/2 of the widths of the two holes 6 in the interelectrode orthogonal direction (D<(a1+a2)/2). In the example illustrated in FIG. 5A, currents corresponding to the currents flowing within the range of halves of the respective widths a1 and a2 of the holes 6, that is, the average (a1+a2)/2 of the widths of the two holes 6 detour around the two adjacent holes 6, and are concentrated within the interval D narrower than the average (a1+a2)/2 of the widths.

Accordingly, the current density becomes extremely high in the region between the two adjacent holes 6. As a result, resistance heat generation is increased, and hence the temperature unevenness becomes extremely large.

FIG. 5B is a view for illustrating a case in which the interval D between the two adjacent holes 6 is equal to the average (a1+a2)/2 of the widths of the two holes 6 in the interelectrode orthogonal direction (D=(a1+a2)/2). In the example illustrated in FIG. 5B, currents corresponding to the currents flowing within the range of the average (a1+a2)/2 of the widths of the two holes 6 detour around the two adjacent holes 6, and are concentrated within the interval D having a width equal to the average (a1+a2)/2 of the widths of the two holes 6. Accordingly, the current density doubles in the region between the two adjacent holes 6. The amount of heat due to resistance heat generation is proportional to the square of current according to Joule's law, and hence the amount of heat generated in the case of the example illustrated in FIG. 5B becomes 4 times as large as the amount of heat generated in a region in which the forward movement of current is not blocked by the holes 6. Also in this case, the temperature unevenness in the heat-generating layer 4 is considerably large.

FIG. 5C is a view for illustrating a case in which the interval D between the two adjacent holes 6 is larger than the average (a1+a2)/2 of the widths of the two holes 6 in the interelectrode orthogonal direction, and is equal to or smaller than the sum (a1+a2) of the widths of the two holes 6 in the interelectrode orthogonal direction ((a1+a2)/2<D<a1+a2). In the example illustrated in FIG. 5C, the increase in current density due to the currents that have detoured around the two holes 6 becomes 1.5 or less times, but the amount of heat generated becomes up to 2.25 times. Accordingly, also in the example illustrated in FIG. 5C, the temperature unevenness in the heat-generating layer 4 is large.

FIG. 5D is a view for illustrating a case in which the interval D between the two adjacent holes 6 is larger than the sum (a1+a2) of the widths of the two holes 6 in the interelectrode orthogonal direction (a1+a2<D). In the example illustrated in FIG. 5D, the increase in current density due to the currents that have detoured around the two holes 6 is significantly suppressed, and hence a suppressing effect on the temperature unevenness in the heat-generating layer 4 can be obtained.

When the interval D between the two adjacent holes 6 is excessively large, particularly in the case where the heating object is small, the presence or absence of the holes 6 in regions of the heat-generating layer 4 that are opposed to the heating object is biased, resulting in an irregular heating pattern. In addition, in the case where the holes 6 are used for hot air generation, when the interval D between the two adjacent holes 6 is excessively large, it becomes difficult to obtain a sufficient air volume and air speed. In addition, in the case where the holes 6 are used for fixing the planar heat-generating element 1, when the interval D between the two adjacent holes 6 is excessively large, the adhesiveness of the planar heat-generating element 1 to the heating object or the strength of fixing thereof may become insufficient. In view of the foregoing, in the present invention, the interval D between the two adjacent holes 6, and the widths a1 and a2 of the two adjacent holes 6 in the second direction satisfy a relationship represented by the following expression (1).

2×(a1+a2)/2<D<10×(a1+a2)/2 (1)

In addition, the D, the a1, and the a2 preferably satisfy a relationship represented by the following expression (2), and more preferably satisfy a relationship represented by the following expression (3).

3×(a1+a2)/2<D<8×(a1+a2)/2 (2)

4×(a1+a2)/2<D<7×(a1+a2)/2 (3)

In the present invention, the planar heat-generating element is preferably configured such that a current flowing between the pair of electrodes when a voltage is applied between the pair of electrodes flows in a direction having a component of a direction parallel to the first direction across the entire region of the heat-generating layer present between the pair of electrodes. With this configuration, the effect of the present invention can be obtained across the entire region of the heat-generating layer present between the pair of electrodes.

As described above, the increase in current density due to the detour of current occurs between the two adjacent holes 6 in the interelectrode orthogonal direction. Even when the positions of the respective centers of the two adjacent holes 6 are not aligned on one and the same straight line parallel to the interelectrode orthogonal direction, the increase in current density occurs if parts of the two holes 6 are adjacent to each other in the interelectrode orthogonal direction. Accordingly, in the present invention, it is meant that the two adjacent holes 6 for defining the interval D are present so as to both overlap one and the same straight line parallel to the interelectrode orthogonal direction (second direction) even slightly. In addition, the interval D between the two adjacent holes 6 is the shortest distance between the respective ends of the two holes 6 in a direction parallel to the interelectrode orthogonal direction (second direction).

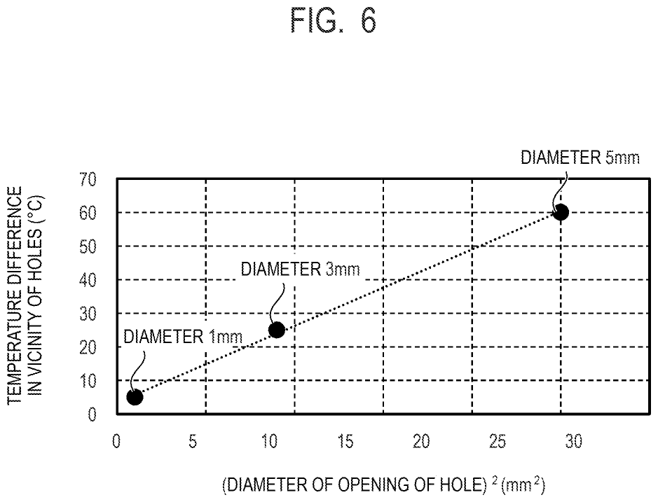

In view of the fact that the heat-generating layer 4 is a thin layer, fluctuation in current density, which serves as the cause of the occurrence of temperature unevenness, is approximately correlated with the area of each of the holes 6, that is, the square of the diameter thereof. FIG. 6 is a graph showing an example of results of evaluation of temperature unevenness in the vicinity of the holes 6 with varying diameters of the openings of the holes 6. An investigation made by the inventors has found that, when the width a1 (=a2) is more than 3 mm, temperature unevenness occurring in the vicinity of the holes 6 exceeds a level at which practical use is possible (20° C. to 30° C.). In order to reduce temperature unevenness in the planar heat-generating element 1 having holes 6 having a width a1 (=a2) of more than 3 mm, it is required according to the present invention that the interval D between the two adjacent holes 6 be set to be as large as more than 6 mm, which may be a configuration unfit for practical use. For this reason, the a1 and the a2 are preferably 3 mm or less.

In addition, when the ratio of the width of each of the holes 6 of the heat-generating layer 4 in the first direction to the width thereof in the second direction is represented by b/a, b/a is preferably 1 or more.

The inside of each of the holes 6 formed in the heat-generating layer 4 may be filled with a component different from a constituent component of the heat-generating layer. For example, the inside may be filled with a constituent component of another layer such as the protective layer 5.

### (Electrodes 3)

The electrodes 3 are to be connected to a power source so as to be able to energize the heat-generating layer 4, and may be formed by printing of a conductive ink or lamination and bonding of conductive foil. A method of forming the electrodes 3 is not particularly limited, but the electrodes may be formed by a method, such as an applicator, a bar coater, screen printing, silk screen printing, gravure printing, flexographic printing, offset printing, or roll transfer printing.

As the conductive ink, there is used, for example, an ink obtained by adding conductive powder formed of, for example, particles or scaly foil pieces of a metal or a metal oxide, such as copper, silver, ITO, or tin oxide, into a binder resin. Commercially available examples of the conductive ink include various pastes each containing silver or copper as a component, such as DD-1630L-245 and DD-3800-103 manufactured by Kyoto Elex Co., Ltd. In addition, for example, the electrodes 3 may be formed by bonding and laminating conductive foil formed of the above-mentioned metal or metal oxide.

### (Protective Layer 5)

The protective layer 5 has a function of preventing a current from flowing when an object or a human body accidentally touches the heat-generating layer 4 and the electrodes 3 during energization.

The protective layer 5 is formed of a material that has a sufficient electrical insulating property and heat resistance enough that strength degradation, deformation, melting, alteration, combustion, or the like does not occur at a desired temperature during a required usage time. A material for forming the protective layer 5 is, for example, an acrylic resin, a polyester resin, a polyimide resin, a polyamide resin, a silicone resin, or a fluororesin, such as polyvinyl fluoride, polyvinylidene fluoride, polytetrafluoroethylene, or an ethylene-tetrafluoroethylene copolymer.

For the protective layer 5, for example, a material that has been formed into a sheet shape in advance may be bonded to the electrodes 3 and the heat-generating layer 4 by a method such as thermal fusion and dry lamination. In addition, the protective layer 5 may be formed on the electrodes 3 and the heat-generating layer 4 in a desired pattern by a printing method, such as screen printing, silk screen printing, gravure printing, flexographic printing, offset printing, or roll transfer printing, using a paste-like material.

The thickness of the protective layer 5 is, for example, from about 20 μm to about 300μm.

### (Processing of Through-Holes)

When the planar heat-generating element 1 is used for hot air generation, the base material 2 and the protective layer 5 each have holes to be connected to the holes 6 of the heat-generating layer 4 at positions corresponding to the holes 6 of the heat-generating layer 4 in order to allow the passage of heated air. The holes of the base material 2 and the protective layer 5, and the holes 6 of the heat-generating layer 4 are hereinafter collectively referred to as “through-holes”.

A processing method for the through-holes is not particularly limited, but examples thereof include methods using a drill, a laser, and a punching die. The centers of the holes of the base material 2 and the protective layer 5 in each of the through-holes are preferably arranged at the same position as the center of the hole 6 of the heat-generating layer 4. The sizes of the openings of the holes of the base material 2 and the protective layer 5 in the through-hole are preferably equal to or smaller than that of the opening of the hole 6 of the heat-generating layer 4. With this configuration, the intrusion of moisture or the like into the heat-generating layer 4 from a portion adjacent to the opening of the through-hole can be prevented. The shapes of the holes of the base material 2 and the protective layer 5 in the through-hole may be identical to or different from the shape of the hole 6 of the heat-generating layer 4. In addition, the cross-sectional shape of the through-hole in a direction perpendicular to the lamination direction of the base material 2, the heat-generating layer 4, and the protective layer 5 may be any of a circular shape and a polygonal shape, and the shape is not particularly limited.

It is preferred that mutually connected holes of the base material 2, the heat-generating layer 4, and the protective layer 5 have cross-sectional shapes identical to each other in directions perpendicular to the lamination direction of the base material 2, the heat-generating layer 4, and the protective layer 5.

### (Heat Generation of Planar Heat-Generating Element 1)

In order to cause the planar heat-generating element 1 to generate heat, a current is caused to flow through the heat-generating layer 4 so that heat may be generated through Joule heat, and a power source for that purpose may be any of DC and AC power sources. In order to keep a constant amount of heat generated, a power source having its current or voltage stabilized is preferred. Further, a fuse or a circuit breaker is preferably mounted in order to prevent a short circuit and any other overcurrent.

### (Hot Air Supply Apparatus)

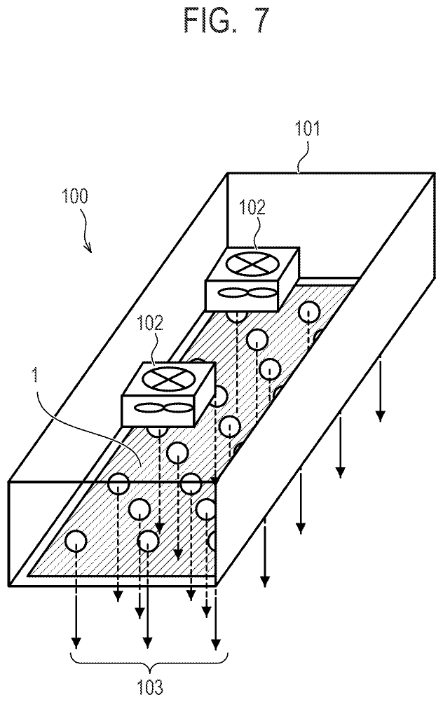

FIG. 7 is a schematic view for illustrating a schematic configuration of a hot air supply apparatus 100 according to one embodiment of the present invention. The hot air supply apparatus 100 uses the planar heat-generating element 1 according to the present invention for hot air generation. The hot air supply apparatus 100 includes a housing 101 having a rectangular parallelepiped shape, an air blower 102 configured to generate an air flow, and the planar heat-generating element 1. The housing 101 is formed of, for example, SUS or aluminum having a thickness of from about 0.5 mm to about 2 mm, and the planar heat-generating element 1 is arranged on at least one surface out of the inner surfaces of the housing 101. In addition, the surface on which the planar heat-generating element 1 is arranged out of the inner surfaces of the housing 101 also has through-holes formed therein so as to coincide with the arrangement of the through-holes formed in the planar heat-generating element 1. The size and shape of each of the through-holes formed in the surface of the housing 101 are not particularly limited, but it is preferred that the size be equal to or one size larger than that of each of the through-holes of the planar heat-generating element 1, and the shape be such that hot air blows out without any problem. The air blower 102 is arranged on a surface out of the inner surfaces of the housing 101 on which the planar heat-generating element 1 is not arranged. A plurality of the air blowers 102 may be arranged in consideration of the volume of the housing 101 and the air volume, air speed, and uniformity of hot air. The air blower 102 has a function of bringing in external air from the outside of the housing 101 and blowing the air into the housing 101, and the amount of the air to be blown may be controlled by a controller (not shown).

The basic operation of the hot air supply apparatus 100 is as described below. First, the air blower 102 is actuated to create a sufficient air flow in the housing 101, and then the planar heat-generating element 1 is energized to be caused to generate heat. Through operation under this state for a certain period of time, heat exchange is performed between the air flow in the housing and the planar heat-generating element 1 to heat the air flow, and hot air 103 blows out from the through-holes to the outside of the housing 101.

### (Inkjet Printer)

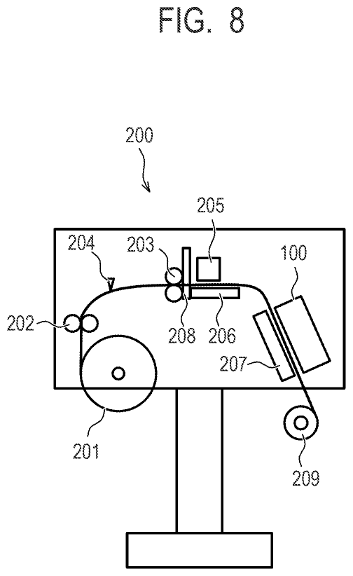

FIG. 8 is a schematic view for illustrating a schematic configuration of an inkjet printer 200 according to one embodiment of the present invention. The inkjet printer 200 includes the hot air supply apparatus 100 according to the present invention. In addition, the inkjet printer 200 further includes sheet-feeding rollers 202 and 203, a sheet-feeding sensor 204, an inkjet head 205, platens 206 and 207, a printer chassis 208, and a take-up portion 209.

The basic operation of the inkjet printer is as described below. First, an end portion of roll paper 201 serving as an example of printing paper is pulled out and fitted to the take-up portion 209 via the platens 206 and 207 configured to smoothly support the roll paper 201. When a printing instruction is received, the roll paper 201 is conveyed by the sheet-feeding rollers 202 and 203 toward the inkjet head 205. In this process, the sheet-feeding sensor 204 detects that the roll paper 201 has been fed.

Subsequently, an ink is ejected with the inkjet head 205 to draw an ink image, which is then conveyed to the hot air supply apparatus 100. The hot air supply apparatus 100 starts hot air generation operation in advance and supplies hot air having a predetermined temperature to dry the ink image on the roll paper 201 in a short period of time. In synchronization with those movements, the roll paper 201 after the printing and the drying is taken up by the take-up portion 209. Finally, the roll paper 201 is cut at a printing completion position to provide a printed image.

### EXAMPLES

The present invention is specifically described below by way of Examples. However, the present invention is by no means limited to the following Examples.

### Example 1

### (Preparation of Conductive Paste)

In this Example, a conductive paste prepared using blending materials and a kneading method described below was used.

The blending materials are as described below.
Conductive powder 1: carbon black (product name: KETJEN BLACK EC300J, manufactured by Lion Specialty Chemicals Co., Ltd.)
Conductive powder 2: graphite (product name: F#3, manufactured by Nippon Graphite Industries, Co., Ltd.)
Binder resin: polyimide varnish (product name: U-Imide Varnish CR, manufactured by Unitika Ltd.)
Solvent: N-methyl-2-pyrrolidone (NMP)

The conductive paste was prepared by sufficiently kneading the above-mentioned blending materials through use of a triple roll mill with their blending ratio appropriately adjusted to achieve a desired volume resistivity and thickness of the film formed.

### (Production of Planar Heat-Generating Element)

A polyimide film with a thickness of 75 μm having an electrical insulating property (product name: UPILEX-S, manufactured by Ube Industries, Ltd.) was used as a base material.

The conductive paste prepared as described above was printed on the base material through use of a screen printing apparatus (product name: MT-650TVC eXtream, manufactured by Micro-tec Co., Ltd.).

After that, the resultant was dried in a drying furnace at 200° C. for 1 hour so that the solvent component was removed. Thus, a heat-generating layer having a thickness of 15 μm was formed. The dimensions of the heat-generating region are a rectangle measuring 250 mm long by 300 mm wide. The heat-generating layer has a plurality of holes in the range of the above-mentioned dimensions. The arrangement and shape of the holes are described later.

Next, a silver paste (product name: DD-1630L-245, manufactured by Kyoto Elex Co., Ltd.) was formed into a film having a strip shape having a width of 5 mm on each of two sides of the heat-generating layer with the above-mentioned screen printing apparatus, and the resultant was dried in a drying furnace at 200° C. for 1 hour so that the solvent component was removed. Thus, a pair of electrodes each having a thickness of 20 μm was formed.

Further, a polyimide varnish (product name: U-Imide Varnish CR, manufactured by Unitika Ltd.) was formed into a film with the above-mentioned screen printing apparatus so as to cover the heat-generating layer and the electrodes except part of each of the electrodes. After that, the resultant was dried in a drying furnace at 200° C. for 1 hour so that the solvent component was removed. Thus, a protective layer having a thickness of 5 μm was formed.

Next, in the region where the base material, the heat-generating layer, and the protective layer were laminated, circular through-holes each having a diameter of 1 mm were formed at the positions of the centers of the holes of the heat-generating layer with a punching die (product name: Flexible Pinnacle Die, manufactured by Tsukatani Hamono Mfg. Co., Ltd.).

Finally, the part of each of the electrodes that had been left uncovered with the protective layer was perforated with a through-hole having a diameter of 3 mm with a punching punch, an electric eyelet was mounted thereonto with a hand press machine, and an electric wire was connected at the eyelet portion through use of solder.

### (Arrangement and Shape of Holes)

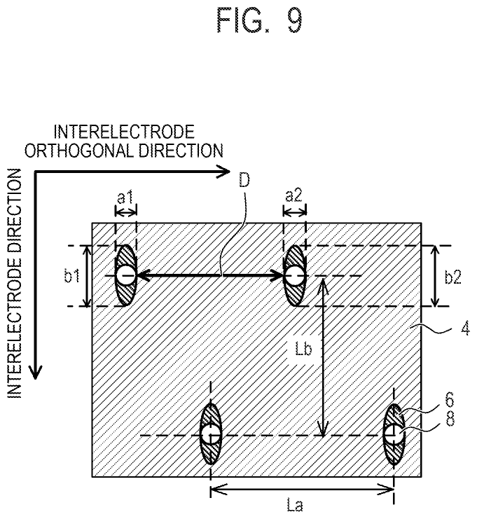

The arrangement and shape of the holes 6 of the heat-generating layer 4 according to this Example are illustrated in FIG. 9.

As described above in the (Relationship between Holes 6 and Temperature Unevenness) section, definitions are made as described below for two holes 6 present adjacent to each other on one and the same straight line parallel to the interelectrode orthogonal direction (hereinafter sometimes referred to simply as “two adjacent holes 6”). First, the widths of the two adjacent holes 6 in the interelectrode orthogonal direction (second direction) are represented by a1 and a2, respectively, and the interval between the two adjacent holes 6 in the interelectrode orthogonal direction is represented by D. In addition, the widths of the two adjacent holes 6 in the interelectrode direction (first direction) are represented by b1 and b2, respectively, and the center-to-center distance between the two adjacent holes 6 in the interelectrode orthogonal direction is represented by La. Further, the center-to-center distance in the interelectrode direction between the center position of a set of two adjacent holes 6 and the center position of another set of two adjacent holes 6 positioned away from the above-mentioned set of holes 6 in the interelectrode direction is represented by Lb. In each of this Example, and Examples and Comparative Examples described below, the positions of the two adjacent holes 6 in the interelectrode direction are identical to each other.

The holes 6 in this Example were arranged in a staggered shape, and each had an elliptical shape. The widths a1 and a2 were each 1 mm, the widths b1 and b2 were each 3 mm, the interval D was 6 mm, the center-to-center distance La was 7 mm, and the center-to-center distance Lb was 6.1 mm. That is, the holes of the heat-generating layer according to this Example satisfied all of the above-mentioned expressions (1) to (3). The opening of each of through-holes 8 was a nearly perfect circle, and the diameter of the opening was 1 mm.

In addition, the hole area ratio in this Example was 5.6%.

### (Temperature Unevenness Evaluation)

A method of evaluating temperature unevenness is described below.

A power of 0.5 W/cm² was applied to the planar heat-generating element according to each of Examples and Comparative Examples from an external power source, and the temperature distribution of a region of the heat-generating layer including a plurality of holes was measured with a thermoviewer. Subsequently, a difference between the average temperature of five portions each of which locally showed the highest temperature in the vicinity of a hole and the average temperature of five portions in the heat-generating region each of which showed the lowest temperature was calculated. A case in which the thus calculated temperature difference was 10° C. or less was graded A, a case in which the temperature difference was more than 10° C. to 25° C. or less was graded B, a case in which the temperature difference was more than 25° C. to 40° C. or less was graded C, and a case in which the temperature difference was more than 40° C. was graded E. The temperature unevenness evaluation for the planar heat-generating element according to this Example was A.

### (Adhesion Fixing Evaluation)

A method of evaluating an adhesion fixing state at a time when the planar heat-generating element according to each of Examples and Comparative Examples is fixed by being bonded to a plate made of SUS is described below.

An adhesive was applied to the back surface of the planar heat-generating element according to each of Examples and Comparative Examples, that is, the surface of its base material on the side on which the heat-generating layer was not laminated in accordance with the positions of the holes of the heat-generating layer, and the resultant was subjected to adhesion fixing by being bonded to a plate made of SUS having a thickness of 0.5 mm. Under this state, the planar heat-generating element was energized to be caused to generate heat, and visual observation was performed for lifting or distortion of the planar heat-generating element.

A case in which the adhesion fixing state was maintained without the occurrence of lifting or distortion was graded A, a case in which 1 to 5 sites of lifting or distortion were observed was graded B, a case in which 5 to 10 sites of lifting or distortion were observed was graded C, and a case in which 11 or more sites of lifting or distortion were observed was graded E. The adhesion fixing evaluation for the planar heat-generating element according to this Example was A.

### Example 2

The conductive paste used in this Example is the same as that of Example 1.

The method of producing the planar heat-generating element is also mostly the same as that of Example 1, but is different in the following points. That is, at the time of the formation of the heat-generating layer on the base material, no holes were formed in the heat-generating layer. Subsequently, after the formation of the electrodes and the protective layer, through-holes were formed simultaneously in the base material, the heat-generating layer, and the protective layer with the punching die.

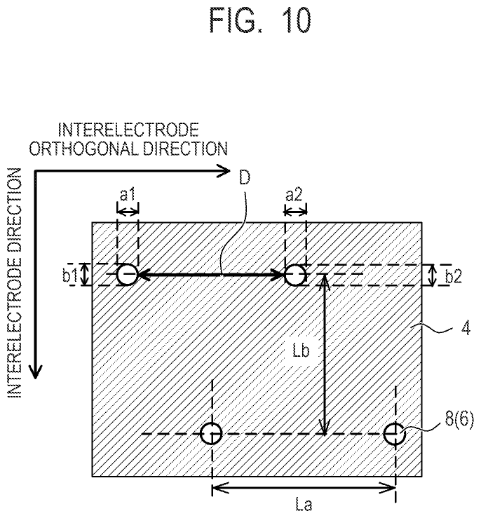

The arrangement and shape of the through-holes 8 (holes 6) formed in this Example are illustrated in FIG. 10.

Portions of the through-holes 8 corresponding to the heat-generating layer 4 are the holes 6 of the heat-generating layer 4. The through-holes 8 were arranged in a staggered shape, and each had an opening shape of a nearly perfect circle. The widths a1, a2, b1, and b2 were each 1 mm, the interval D was 6 mm, the center-to-center distance La was 7 mm, and the center-to-center distance Lb was 6.1 mm. That is, the holes of the heat-generating layer according to this Example satisfied all of the above-mentioned expressions (1) to (3). In addition, the hole area ratio in this Example was 1.9%.

For the planar heat-generating element according to this Example, the temperature unevenness evaluation was A, and the adhesion fixing evaluation was A.

### Example 3

The conductive paste used in this Example is the same as that of Example 1.

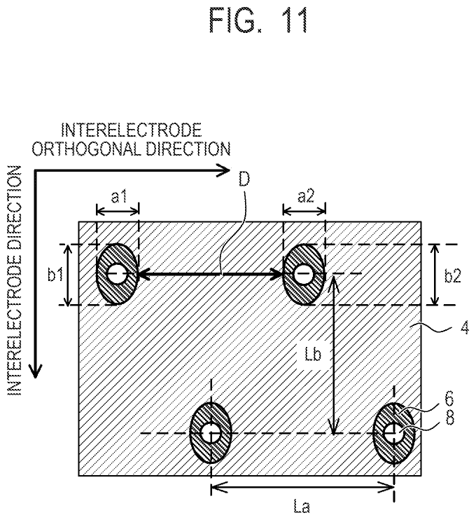

The method of producing the planar heat-generating element is also mostly the same as that of Example 1, but is different in the following points. The arrangement and shape of each of the holes 6 and the through-holes 8 formed in this Example are illustrated in FIG. 11. The holes 6 were arranged in a staggered shape, and each had an elliptical opening. The widths a1 and a2 were each 2 mm, the widths b1 and b2 were each 3 mm, the interval D was 3.5 mm, the center-to-center distance La was 9 mm, and the center-to-center distance Lb was 7.8 mm. That is, the holes of the heat-generating layer according to this Example satisfied the above-mentioned expressions (1) and (2). The through-holes 8 were formed so that their centers were at the same positions as those of the holes 6, and the opening of each of the through-holes 8 had a nearly perfect circle shape having a diameter of 1 mm. In addition, the hole area ratio in this Example was 6.7%.

For the planar heat-generating element according to this Example, the temperature unevenness evaluation was B, and the adhesion fixing evaluation was A.

### Example 4

The conductive paste used in this Example is the same as that of Example 1. The method of producing the planar heat-generating element is also mostly the same as that of Example 1, but is different in the following points. That is, at the time of the formation of the protective layer, the holes of the heat-generating layer were filled with the material for forming the protective layer.

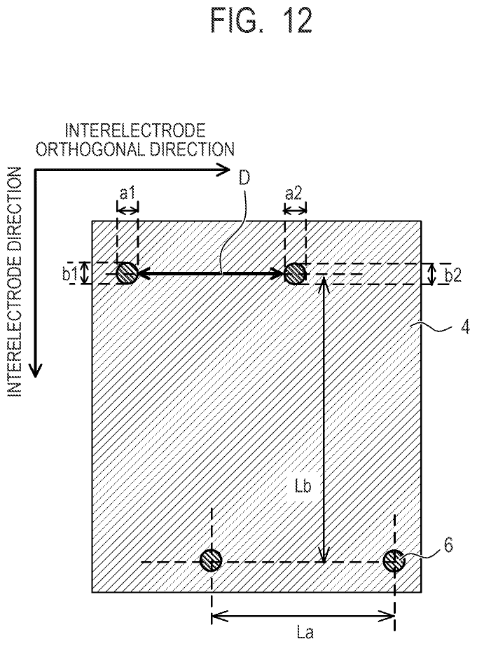

The arrangement and shape of the holes 6 formed in this Example are illustrated in FIG. 12.

The holes 6 were arranged in a staggered shape, and each had an opening of a nearly perfect circle shape. The widths a1, a2, b1, and b2 were each 1 mm, the interval D was 8 mm, the center-to-center distance La was 9 mm, and the center-to-center distance Lb was 16 mm. That is, the holes of the heat-generating layer according to this Example satisfied the above-mentioned expression (1). In addition, the hole area ratio in this Example was 0.5%.

For the planar heat-generating element according to this Example, the temperature unevenness evaluation was A, and the adhesion fixing evaluation was C.

### Example 5

The conductive paste used in this Example is the same as that of Example 1. The method of producing the planar heat-generating element is also mostly the same as that of Example 4, but the arrangement of the holes 6 is different in the following points. That is, the interval D was 3 mm, the center-to-center distance La was 4 mm, and the center-to-center distance Lb was 1.3 mm. That is, the holes of the heat-generating layer according to this Example satisfied the above-mentioned expression (1). In addition, the hole area ratio in this Example was 15.0%.

For the planar heat-generating element according to this Example, the temperature unevenness evaluation was C, and the adhesion fixing evaluation was A.

### Example 6

The conductive paste used in this Example is the same as that of Example 1. The method of producing the planar heat-generating element is mostly the same as that of Example 2, but the shape and arrangement of the holes 6 are different in the following points. That is, the holes 6 each had an elliptical opening shape, the widths a1 and a2 were each 0.5 mm, the widths b1 and b2 were each 4 mm, the interval D was 2.5 mm, the center-to-center distance La was 6 mm, and the center-to-center distance Lb was 2 mm. That is, the holes of the heat-generating layer according to this Example satisfied all of the above-mentioned expressions (1) to (3). In addition, the hole area ratio in this Example was 13.1%.

For the planar heat-generating element according to this Example, the temperature unevenness evaluation was A, and the adhesion fixing evaluation was A.

### Example 7

The conductive paste used in this Example is the same as that of Example 1. The method of producing the planar heat-generating element is also mostly the same as that of Example 1, but the shape and arrangement of the holes 6 are different in the following points. That is, the holes 6 each had a nearly perfect circle shape, the widths a1 and a2 were each 3 mm, the widths b1 and b2 were each 3 mm, the interval D was 18 mm, the center-to-center distance La was 21 mm, and the center-to-center distance Lb was 18.2 mm. That is, the holes of the heat-generating layer according to this Example satisfied all of the above-mentioned expressions (1) to (3). In addition, the hole area ratio in this Example was 1.9%.

For the planar heat-generating element according to this Example, the temperature unevenness evaluation was A, and the adhesion fixing evaluation was A.

### Example 8

The conductive paste used in this Example is the same as that of Example 1. The method of producing the planar heat-generating element is mostly the same as that of Example 2, but the shape and arrangement of the holes 6 are different.

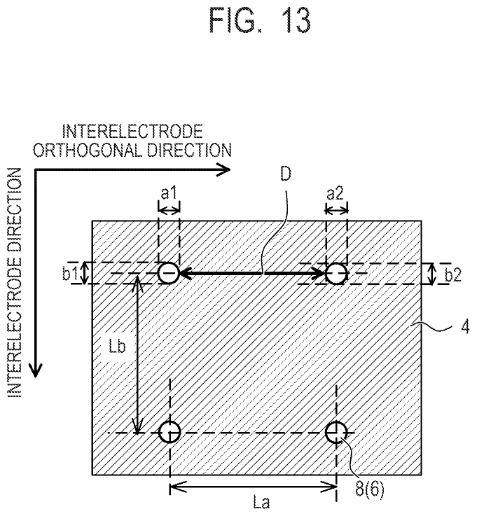

The arrangement and shape of the through-holes 8 (holes 6) formed in this Example are illustrated in FIG. 13.

The holes 6 were arranged in a lattice shape, and each had an opening of a nearly perfect circle shape. In addition, the widths a1, a2, b1, and b2 were each 1 mm, the interval D was 7 mm, and the center-to-center distances La and Lb were each 8 mm. That is, the holes of the heat-generating layer according to this Example satisfied the above-mentioned expressions (1) and (2).

In addition, the hole area ratio in this Example was 1.2%.

For the planar heat-generating element according to this Example, the temperature unevenness evaluation was A, and the adhesion fixing evaluation was B.

### Example 9

The conductive paste used in this Example is the same as that of Example 1. The method of producing the planar heat-generating element is mostly the same as that of Example 2, but the shape and arrangement of the holes 6 are different.

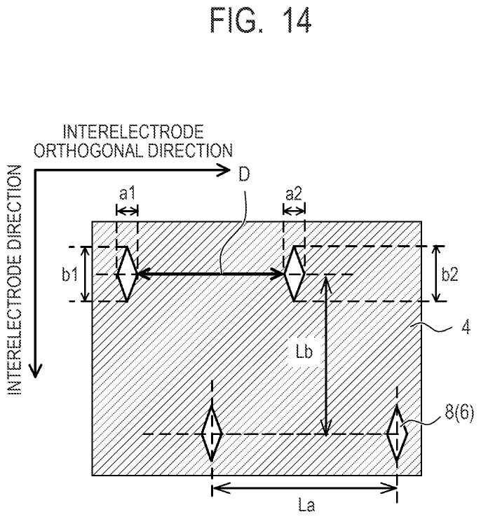

The arrangement and shape of the through-holes 8 (holes 6) formed in this Example are illustrated in FIG. 14.

The holes 6 were arranged in a staggered shape, and each had a rhombic opening shape. In addition, the widths a1 and a2 were each 1 mm, the widths b1 and b2 were each 3 mm, the interval D was 6 mm, the center-to-center distance La was 7 mm, and the center-to-center distance Lb was 6.1 mm. That is, the holes of the heat-generating layer according to this Example satisfied all of the above-mentioned expressions (1) to (3). In addition, the hole area ratio in this Example was 3.5%.

For the planar heat-generating element according to this Example, the temperature unevenness evaluation was A, and the adhesion fixing evaluation was A.

### Example 10

The conductive paste used in this Example is the same as that of Example 1. The method of producing the planar heat-generating element is mostly the same as that of Example 2, but the shape and arrangement of the holes 6 are different.

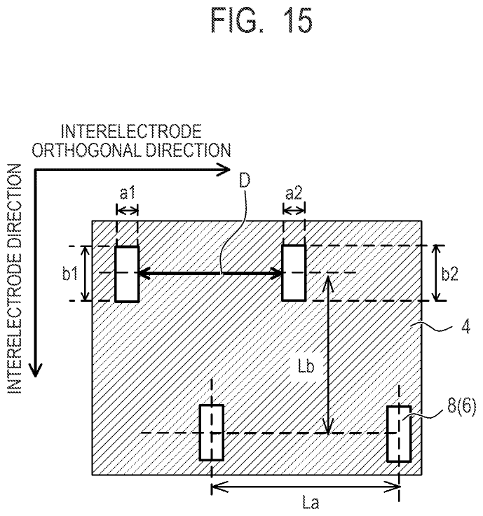

The arrangement and shape of the through-holes 8 (holes 6) formed in this Example are illustrated in FIG. 15.

The holes 6 were arranged in a staggered shape, and each had a rectangular opening shape. In addition, the widths a1 and a2 were each 1 mm, the widths b1 and b2 were each 3 mm, the interval D was 2.5 mm, the center-to-center distance La was 7 mm, and the center-to-center distance Lb was 3 mm. That is, the holes of the heat-generating layer according to this Example satisfied the above-mentioned expression (1). In addition, the hole area ratio in this Example was 14.3%.

For the planar heat-generating element according to this Example, the temperature unevenness evaluation was C, and the adhesion fixing evaluation was A.

### Example 11

The conductive paste used in this Example is the same as that of Example 1. The method of producing the planar heat-generating element is mostly the same as that of Example 2, but the shape and arrangement of the holes 6 are different.

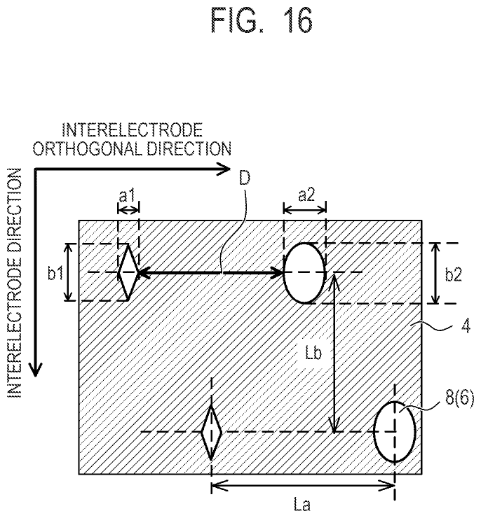

The arrangement and shape of the through-holes 8 (holes 6) formed in this Example are illustrated in FIG. 16.

The holes 6 were arranged in a staggered shape, and holes 6 each having a rhombic opening shape and holes 6 each having an elliptical opening shape were alternately arranged. The width a1 of each of the holes 6 having a rhombic opening shape was 1 mm, the width a2 of each of the holes 6 having an elliptical opening shape was 2 mm, and the width b1 of each of the holes 6 having a rhombic opening shape and the width b2 of each of the holes 6 having an elliptical opening shape were each 3 mm. In addition, the interval D was 6 mm, the center-to-center distance La was 7 mm, and the center-to-center distance Lb was 6.1 mm. That is, the holes of the heat-generating layer according to this Example satisfied the above-mentioned expressions (1) and (2). In addition, the hole area ratio in this Example was 4.5%.

For the planar heat-generating element according to this Example, the temperature unevenness evaluation was A, and the adhesion fixing evaluation was A.

### Comparative Example 1

The conductive paste used in this Comparative Example is the same as that of Example 1. The method of producing the planar heat-generating element is mostly the same as that of Example 4, but the arrangement of the holes 6 is different in the following points. That is, the interval D was 11 mm, the center-to-center distance La was 12 mm, and the center-to-center distance Lb was 16 mm. That is, the holes of the heat-generating layer according to this Example did not satisfy the above-mentioned expression (1). In addition, the hole area ratio in this Example was 0.4%.

For the planar heat-generating element according to this Example, the temperature unevenness evaluation was A, and the adhesion fixing evaluation was E.

### Comparative Example 2

The conductive paste used in this Comparative Example is the same as that of Example 1. The method of producing the planar heat-generating element is mostly the same as that of Example 4, but the arrangement of the holes 6 is different in the following points. That is, the interval D was 2 mm, the center-to-center distance La was 3 mm, and the center-to-center distance Lb was 1.7 mm. That is, the holes of the heat-generating layer according to this Example did not satisfy the above-mentioned expression (1). In addition, the hole area ratio in this Example was 15.4%.

For the planar heat-generating element according to this Example, the temperature unevenness evaluation was E, and the adhesion fixing evaluation was A.

### Comparative Example 3

The conductive paste used in this Example is the same as that of Example 1. The method of producing the planar heat-generating element is also mostly the same as that of Example 1, but the shape and arrangement of the holes 6 are different in the following points. That is, the widths a1 and a2 were each 4 mm, the widths b1 and b2 were each 3 mm, the interval D was 8 mm, the center-to-center distance La was 12 mm, and the center-to-center distance Lb was 10.4 mm. That is, the holes of the heat-generating layer according to this Example did not satisfy the above-mentioned expression (1). In addition, the hole area ratio in this Example was 7.6%.

For the planar heat-generating element according to this Example, the temperature unevenness evaluation was E, and the adhesion fixing evaluation was A.

Table 1 shows the arrangement and shape of the holes of the heat-generating layer, the form of the through-holes, the hole area ratio, the expression(s) satisfied for the relationship among a1, a2, and D, and the evaluation results of temperature unevenness and adhesion fixing for the planar heat-generating element produced in each of Examples and Comparative Examples. In the description of the through-holes in Table 1, “Inside” means that the openings of the through-holes in the base material and the protective layer are positioned inside the openings of the holes of the heat-generating layer, and “Same shape” means that the openings of the through-holes in the base material and the protective layer and the openings of the holes of the heat-generating layer have the same shape.

TABLE 1

| | Holes of heat-generating layer | | | | | | | | |
|---|---|---|---|---|---|---|---|---|---|
| | | | | | Widths | Ratio | Ratio | | |
| | | | Width | Width | b1 and | between | between | Interval | D/ |
| | | Opening | a1 | a2 | b2 | widths | widths | D | ((a1 + |
| | Arrangement | shape | (mm) | (mm) | (mm) | b1/a1 | b2/a2 | (mm) | a2)/2) |
| Exam- | Staggered | Ellipse | 1 | 1 | 3 | 3 | 3 | 6 | 6 |
| ple 1 | shape | | | | | | | | |
| Exam- | Staggered | Perfect | 1 | 1 | 1 | 1 | 1 | 6 | 6 |
| ple 2 | shape | circle | | | | | | | |
| Exam- | Staggered | Ellipse | 2 | 2 | 3 | 1.5 | 1.5 | 7 | 3.5 |
| ple 3 | shape | | | | | | | | |
| Exam- | Staggered | Perfect | 1 | 1 | 1 | 1 | 1 | 8 | 8 |
| ple 4 | shape | circle | | | | | | | |
| Exam- | Staggered | Perfect | 1 | 1 | 1 | 1 | 1 | 3 | 3 |
| ple 5 | shape | circle | | | | | | | |
| Exam- | Staggered | Ellipse | 0.5 | 0.5 | 4 | 8 | 8 | 2.5 | 5 |
| ple 6 | shape | | | | | | | | |
| Exam- | Staggered | Perfect | 3 | 3 | 3 | 1 | 1 | 18 | 6 |
| ple 7 | shape | circle | | | | | | | |
| Exam- | Lattice | Perfect | 1 | 1 | 1 | 1 | 1 | 7 | 7 |
| ple 8 | shape | circle | | | | | | | |
| Exam- | Staggered | Rhombus | 1 | 1 | 3 | 3 | 3 | 6 | 6 |
| ple 9 | shape | | | | | | | | |
| Exam- | Staggered | Rectangle | 1 | 1 | 3 | 3 | 3 | 2.5 | 2.5 |
| ple 10 | shape | | | | | | | | |
| Exam- | Staggered | Rhombus | 1 | 2 | 3 | 3 | 1.5 | 5.5 | 3.7 |
| ple 11 | shape | and | | | | | | | |
| | | ellipse | | | | | | | |
| Compar- | Staggered | Perfect | 1 | 1 | 1 | 1 | 1 | 11 | 11 |
| ative | shape | circle | | | | | | | |
| Exam- | | | | | | | | | |
| ple 1 | | | | | | | | | |
| Compar- | Staggered | Perfect | 1 | 1 | 1 | 1 | 1 | 2 | 2 |
| ative | shape | circle | | | | | | | |
| Exam- | | | | | | | | | |
| ple 2 | | | | | | | | | |
| Compar- | Staggered | Ellipse | 4 | 4 | 3 | 0.75 | 0.75 | 8 | 2 |
| ative | shape | | | | | | | | |
| Exam- | | | | | | | | | |
| ple 3 | | | | | | | | | |

| | | Center-to-center | | Hole | | | |
|---|---|---|---|---|---|---|---|
| | | distance | | area | | Evaluation | |
| | Through- | La | Lb | ratio | Expression(s) | Temperature | Adhesion |
| | holes | (mm) | (mm) | (%) | satisfied | unevenness | fixing |
| Exam- | Inside | 7 | 6.1 | 5.6% | (1), (2), and | A | A |
| ple 1 | | | | | (3) | | |
| Exam- | Same | 7 | 6.1 | 1.9% | (1), (2), and | A | A |
| ple 2 | shape | | | | (3) | | |
| Exam- | Inside | 9 | 7.8 | 6.7% | (1) and (2) | B | A |
| ple 3 | | | | | | | |
| Exam- | — | 9 | 16.0 | 0.5% | (1) | A | C |
| ple 4 | | | | | | | |
| Exam- | — | 4 | 1.3 | 15.0% | (1) | C | A |
| ple 5 | | | | | | | |
| Exam- | Same | 6 | 2.0 | 13.1% | (1), (2), and | A | A |
| ple 6 | shape | | | | (3) | | |
| Exam- | Inside | 21 | 18.2 | 1.9% | (1), (2), and | A | A |
| ple 7 | | | | | (3) | | |
| Exam- | Same | 8 | 8.0 | 1.2% | (1) | A | B |
| ple 8 | shape | | | | | | |
| Exam- | Same | 7 | 6.1 | 3.5% | (1), (2), and | A | A |
| ple 9 | shape | | | | (3) | | |
| Exam- | Same | 7 | 3.0 | 14.3% | (1) | C | A |
| ple 10 | shape | | | | | | |
| Exam- | Same | 7 | 6.1 | 4.5% | (1) and (2) | B | A |
| ple 11 | shape | | | | | | |
| Compar- | — | 12 | 16.0 | 0.4% | — | A | E |
| ative | | | | | | | |
| Exam- | | | | | | | |
| ple 1 | | | | | | | |
| Compar- | — | 3 | 1.7 | 15.4% | — | E | A |
| ative | | | | | | | |
| Exam- | | | | | | | |
| ple 2 | | | | | | | |
| Compar- | Inside | 12 | 10.4 | 7.6% | — | E | A |
| ative | | | | | | | |
| Exam- | | | | | | | |
| ple 3 | | | | | | | |

### [Second Embodiment]

A planar heat-generating element according to a second embodiment includes: a base material; a heat-generating layer arranged on the base material; electrodes to be brought into contact with the heat-generating layer; and a protective layer covering the electrodes and the heat-generating layer, the planar heat-generating element having one or more through-holes penetrating through the base material, the heat-generating layer, and the protective layer, wherein a through-hole adjacent portion of the heat-generating layer is thicker, or has a lower volume resistivity, than another portion of the heat-generating layer. Differences from the first embodiment are mainly described below.

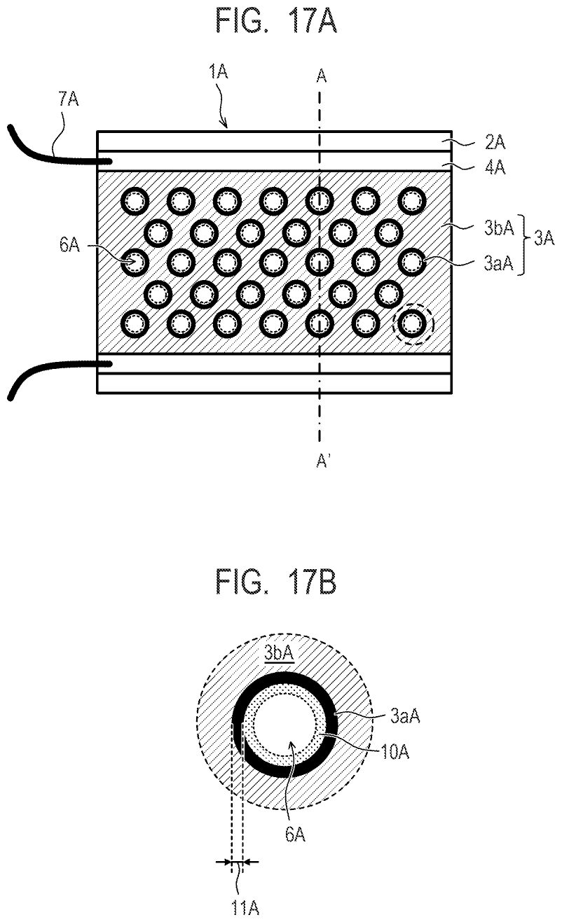

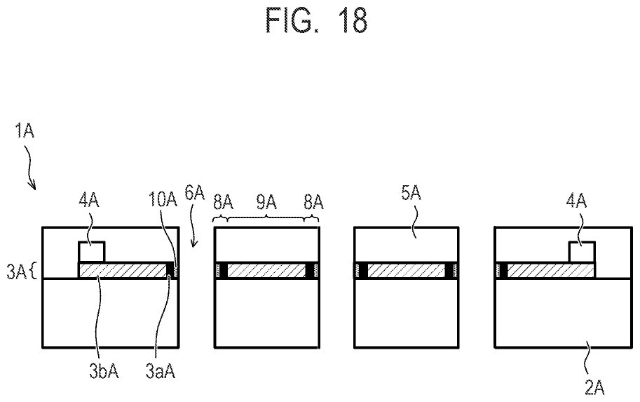

FIG. 17A and FIG. 17B are top views of a planar heat-generating element 1A, and FIG. 18 is a cross-sectional schematic view taken along the line A-A′ of FIG. 17A. It should be noted that, in FIG. 17A and FIG. 17B, a protective layer 5A is omitted for the sake of description. The planar heat-generating element 1A includes a base material 2A, a heat-generating layer 3A, electrodes 4A, and the protective layer 5A. In addition, the planar heat-generating element 1A has through-holes 6A. In the heat-generating layer 3A, a through-hole adjacent portion 3aA, which is a portion adjacent to each through-hole 6A, preferably has a width 11A that is equal to the radius of the through-hole 6A or smaller than the radius of the through-hole 6A. The through-hole adjacent portion 3aA of the heat-generating layer 3A is thicker, or has a lower volume resistivity, than another portion 3bA of the heat-generating layer 3A. With such configuration, when power is applied to the electrodes 4A, a temperature (Y [° C.]) of a through-hole neighboring portion 8A of the surface of the planar heat-generating element and a temperature (X [° C.]) of a portion of the surface other than the through-hole neighboring portion satisfy X<Y. It is more preferred that, when a power of 1.0 W/cm² is applied to the electrodes 4A, 0 [° C]<Y-X≤30 [° C.] be satisfied. The “through-hole neighboring portion 8A” refers to a region around the through-hole 6A in the surface of the planar heat-generating element 1A, the region being at a distance from the through-hole 6A equal to or smaller than the radius of the through-hole 6A.

The “thickness of the through-hole adjacent portion 3aA of the heat-generating layer” and the “thickness of the other portion 3bA of the heat-generating layer 3A” each refer to the average thickness of the heat-generating layer in the relevant portion. The thickness of the heat-generating layer 3A may be roughly uniform or nonuniform in the relevant portion. When the thickness is nonuniform in the through-hole adjacent portion 3aA, it is preferred that the thickness increase gradually with increased closeness to the through-hole 6A.

A portion 10A where the heat-generating layer is not arranged is preferably present in the vicinity of the through-hole. However, this is not a feature essential to the present disclosure.

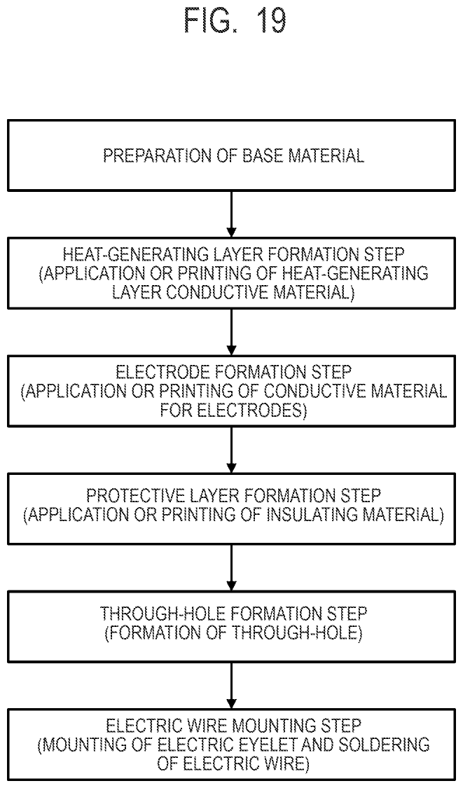

The manufacturing flow of a method of manufacturing the planar heat-generating element according to one embodiment of the present disclosure is illustrated in FIG. 19. The method of manufacturing the planar heat-generating element of the present disclosure includes: a heat-generating layer formation step of applying or printing a heat-generating layer conductive material (conductive paste) onto a base material; an electrode formation step of applying or printing a conductive material for electrodes onto the base material having formed thereon the heat-generating layer; a protective layer formation step of applying or printing an insulating material onto the base material having formed thereon the heat-generating layer and the electrodes; and a through-hole formation step of forming a through-hole penetrating from the protective layer to the base material.

When the planar heat-generating element 1A is manufactured by the above-mentioned manufacturing method, the thickness of the heat-generating layer 3A around the through-hole is slightly increased in the through-hole formation step in some cases. Depending on the composition and thickness of the heat-generating layer, the through-hole adjacent portion 3aA of the heat-generating layer may be slightly increased in thickness as compared to the other portion 3bA of the heat-generating layer. As a result, the planar heat-generating element 1A satisfies the above-mentioned relationship X<Y when energized.

In addition, in the heat-generating layer formation step of the above-mentioned manufacturing method, the heat-generating layer 3A may be formed by applying or printing the heat-generating layer conductive material under such a setting that the heat-generating layer conductive material is not arranged at the processing position of the through-hole 6A.

Further, the heat-generating layer 3A may be formed by applying or printing the heat-generating layer conductive material under such a setting that the heat-generating layer conductive material is not arranged at the processing position of the through-hole 6A and in the vicinity thereof. Thus, the portion 10A where the heat-generating layer 3A is not arranged is formed in the vicinity of the through-hole, and in this portion, the protective layer 5A is formed. Thus, also at the through-hole 6A, the heat-generating layer 3A is covered with the protective layer 5A, and hence electric leakage and the intrusion of moisture or the like into the heat-generating layer can be prevented.

When the heat-generating layer conductive material is applied or printed, the heat-generating layer conductive material is retained in a larger amount at the end edge of the region in which the heat-generating layer conductive material is arranged than at any other portion. Based on this phenomenon, when the heat-generating layer conductive material is applied or printed while avoiding the vicinity of the through-hole, the through-hole adjacent portion 3aA of the heat-generating layer becomes slightly thicker than the other portion 3bA. As a result, the planar heat-generating element 1A satisfies the above-mentioned relationship X<Y when energized.

Still further, the heat-generating layer conductive material may be arranged so that the through-hole adjacent portion 3aA of the heat-generating layer may be thicker than the other portion 3bA of the heat-generating layer 3A. Thus, the through-hole adjacent portion 3aA of the heat-generating layer becomes thicker than the other portion 3bA more efficiently.

In addition, the heat-generating layer conductive material may be applied or printed so that the through-hole adjacent portion 3aA of the heat-generating layer may have a lower volume resistivity than the other portion 3bA of the heat-generating layer 3A. Thus, the above-mentioned relationship X<Y can be satisfied still more efficiently at the time of energization.

Details about each constituent element of the planar heat-generating element 1A and a manufacturing process thereof are described below.

### (Heat-Generating Layer)

In the planar heat-generating element 1A, the actual resistance value of the through-hole adjacent portion 3aA of the heat-generating layer 3A is small as compared to the other portion 3bA of the heat-generating layer 3A. That is, the thickness of the through-hole adjacent portion 3aA of the heat-generating layer 3A is thick as compared to the thickness of the other portion 3bA of the heat-generating layer 3A, or the volume resistivity of the through-hole adjacent portion 3aA of the heat-generating layer 3A is small as compared to the volume resistivity of the other portion 3bA of the heat-generating layer 3A.

The heat-generating layer 3A may be formed by applying or printing the heat-generating layer conductive material under such a setting that the heat-generating layer conductive material is not arranged at the position at which the through-hole 6A is processed. Portions where the heat-generating layer conductive material is not arranged (non-printed portions) are preferably arranged in a lattice shape or a staggered shape on the heat-generating layer 3A. Each of the non-printed portions may have a circular shape, an elliptical shape, a rectangular shape, or a polygonal shape, and the shape is not particularly limited. The non-printed portion is preferably larger than the through-hole 6A. Thus, the portion 10A where the heat-generating layer is not arranged is formed in the vicinity of the through-hole. The diameter of the non-printed portion is preferably 2 or less times as large as the diameter of the through-hole 6A. When the shape is a circle, the diameter means the diameter of the circle, and when the shape is other than a circle, the diameter means the diameter of a circle having an equal area.

In the planar heat-generating element 1A of the present disclosure, at the time of energization, the temperature of the through-hole neighboring portion 8A becomes high as compared to the temperature of another portion 9A. Air blown from an air blower is heated by the planar heat-generating element 1A, passes through the through-hole 6A, and is discharged to the outside. The air receives the largest amount of heat from the planar heat-generating element 1A when its contact time with the planar heat-generating element 1A is longest, that is, at the time of the passage through the through-hole. The amount of heat transfer from the planar heat-generating element 1A to the air is expressed as the product of a heat transfer coefficient, a surface area, and a temperature difference between the planar heat-generating element 1A and the air. As the temperature of the through-hole neighboring portion 8A of the planar heat-generating element 1A becomes higher, the amount of heat transfer from the planar heat-generating element 1A to the air becomes larger, and as a result, the temperature of the air to be discharged to the outside becomes higher.

Further, in the planar heat-generating element 1A, at the time of energization, a difference between the temperature of the through-hole neighboring portion 8A and the temperature of the other portion 9A is preferably 30° C. or less. When the difference is more than 30° C., a difference occurs in ratio of volume expansion in the plane of the planar heat-generating element 1A, with the result that warping or waviness is liable to occur. As a result, the uniformity of air speed in the plane of the planar heat-generating element 1A at a time when air that has been blown from the air blower and has passed through the through-hole 6A is discharged to the outside is sometimes degraded.

When the heat-generating layer 3A is formed with the non-printed portion arranged therein, one preferred approach to making the thickness of the through-hole adjacent portion 3aA of the heat-generating layer 3A thick as compared to the thickness of the other portion 3bA of the heat-generating layer 3A is, for example, the use of screen printing for the formation of the heat-generating layer 3A. In the screen printing, an ink is placed on a screen printing plate lined with a mesh, and is extruded to the opposite side with a spatula called a squeegee to print the ink on an object. In the screen printing plate, an emulsion made of a resin is arranged at the non-printed portion so that the ink is not extruded to the opposite side. Accordingly, at the time of printing, the ink is easily retained around the emulsion positioned at the non-printed portion. Through utilization of this phenomenon for the formation of the heat-generating layer 3A, the through-hole adjacent portion 3aA of the heat-generating layer 3A can be made thick as compared to the other portion 3bA of the heat-generating layer 3A. In order to more effectively utilize this phenomenon, the heat-generating layer 3A may be formed with a further adjustment to a printing speed or the viscosity of the heat-generating layer conductive material. Still further, the through-hole adjacent portion 3aA can be made thicker as compared to the other portion 3bA of the heat-generating layer 3A by reducing the printing speed or increasing the viscosity of the heat-generating layer conductive material.

In addition, the thickness may be made thick by performing repeated application on only the through-hole adjacent portion 3aA through screen printing, any other type of printing, or application. The thickness of the through-hole adjacent portion 3aA of the heat-generating layer 3A is preferably 120% or less, more preferably 115% or less of the thickness of the other portion 3bA of the heat-generating layer 3A from the viewpoints of the heat resistance of constituent materials for the planar heat-generating element 1A and the deformation of the base material 2A.

That is, when the thickness of the through-hole adjacent portion 3aA of the heat-generating layer 3A is represented by T1 [μm], and the thickness of the other portion 3bA of the heat-generating layer 3A is represented by T2 [μm], it is preferred to satisfy 1<T1/T2≤1.2.

The width 11A of the through-hole adjacent portion 3aA is preferably equal to or smaller than the radius of the through-hole 6A from the viewpoints of the heat resistance of the constituent materials for the planar heat-generating element 1A and the deformation of the base material 2A. When the width 11A falls outside this range, there is a risk in that sufficient heating cannot be obtained at the through-hole 6A.

In order to make the volume resistivity of the through-hole adjacent portion 3aA of the heat-generating layer 3A small as compared to the volume resistivity of the other portion 3bA of the heat-generating layer 3A, the through-hole adjacent portion 3aA (low volume resistivity) of the heat-generating layer 3A and the other portion 3bA (high volume resistivity) of the heat-generating layer 3A may be formed with heat-generating layer conductive materials different from each other in volume resistivity. Each portion may be formed using screen printing or the like, and the order of formation, i.e., which of the different heat-generating layer conductive materials is used first is not limited. The thickness of the through-hole adjacent portion 3aA (low volume resistivity) and the thickness of the other portion 3bA (high volume resistivity) are not limited to the extent that the magnitude relationship of their actual resistance values is satisfied, but a difference between their respective thicknesses is preferably 2.0 μm or less from the viewpoint of the adhesiveness of the protective layer 5A. The width 11A of the region of the through-hole adjacent portion 3aA (low volume resistivity) is preferably equal to or smaller than the radius of the through-hole 6A from the viewpoints of the heat resistance of the constituent materials for the planar heat-generating element 1A and the deformation of the base material 2A.

### (Through-Hole)

The planar heat-generating element 1A, which is formed of the base material 2A, the heat-generating layer 3A, the electrodes 4A, and the protective layer 5A, has the through-hole 6A for the passage of air. The planar heat-generating element 1A has formed therein one or more of the through-holes 6A. In order for the planar heat-generating element 1A to be used as the hot air supply apparatus 100 to be described later, it is more preferred that a plurality of the through-holes 6A be formed.

When the heat-generating layer 3A is formed with a non-printed portion arranged therein, the through-hole 6A may be made concentric with the non-printed portion. In addition, the through-holes 6A may be formed through perforation in a lattice shape or staggered shape arrangement as with the non-printed portions. In this case, when the diameter of the through-hole 6A is set to be smaller than the diameter of the non-printed portion, the vicinity of the through-hole does not have the heat-generating layer, and the portion 10A where the heat-generating layer is not arranged is formed, and this portion is formed of the protective layer 5A. With this configuration, the intrusion of moisture or the like into the heat-generating layer 3A from the side surface of the through-hole 6A can be prevented, and electric leakage can also be prevented. Specifically, the diameter of the through-hole 6A is preferably from about 1 mm to about 10 mm. The shape of the through-hole 6A may differ from the shape of the non-printed portion, and may be an elliptical shape, a rectangular shape, or a polygonal shape besides a circular shape, and the shape is not particularly limited. When the shape is a circle, the diameter means the diameter of the circle, and when the shape is other than a circle, the diameter means the diameter of a circle having an equal area.

### (Heat-Generating Sheet)

The planar heat-generating element 1A preferably has a thickness of 2.0 mm or less. When the thickness is 2.0 mm or less, the planar heat-generating element 1A is sufficiently thin and compact, has a wide heat-generating area with respect to its volume, and is effective for use in a space heating device or a warming device. The planar heat-generating element 1A that is sufficiently thin may be used as a heat-generating sheet.

### EXAMPLES

The present invention is specifically described below by way of Examples.

### Example 1A

### (Production of Heat-Generating Layer Conductive Material)

In this Example, a heat-generating layer conductive material originally blended by the inventors was used. Blending materials and a kneading method are described below.

### Blending Materials

Conductive powder 1: carbon black
   KETJEN BLACK EC300J manufactured by Lion Specialty Chemicals Co., Ltd.
Conductive powder 2: graphite
   F#3 manufactured by Nippon Graphite Industries, Co., Ltd.
Binder resin:
   U-Imide Varnish CR manufactured by Unitika Ltd.
Solvent: N-methyl-2-pyrrolidone (NMP)

A heat-generating layer conductive material was produced by sufficiently kneading the above-mentioned blending materials through use of a triple roll mill with their blending ratio appropriately adjusted to achieve a desired volume resistivity and thickness of the film formed. The volume resistivity of the heat-generating layer conductive material was measured with a resistance meter (MCP-T250 manufactured by Mitsubishi Petrochemical Co., Ltd.), and was found to be 3.0×10⁻² Ω·cm.

### (Production of Planar Heat-Generating Element)

An electrically insulating polyimide film having a thickness of 75 μm (UPILEX-S manufactured by Ube Industries, Ltd.) was used as a base material. The heat-generating layer conductive material described above was formed into a film thereon with a screen printing apparatus (MT-650TVC eXtream manufactured by Micro-tec Co., Ltd.) at a printing speed of 50 m/s. The dimensions of the film-formed region are a rectangle measuring 250 mm long by 300 mm wide, and a plurality of non-printed portions are included in this range. With regard to the pattern of non-printed portions, circular shapes each having a diameter of 2 mm were arranged in a 60° staggered shape at intervals of 7 mm. The resultant was dried in a drying furnace at 200° C. for 1 hour so that the solvent component was removed. Thus, a heat-generating layer was formed. Next, a silver paste (DD-1630L-245 manufactured by Kyoto Elex Co., Ltd.) was formed into a film of a strip shape having a width of 5 mm on each of two sides of the heat-generating layer with the screen printing apparatus, and the resultant was dried in a drying furnace at 200° C. for 1 hour so that the solvent component was removed. Thus, a pair of electrodes each having a thickness of 20 μm was formed. Further, a polyimide varnish (U-Imide Varnish CR manufactured by Unitika Ltd.) was formed into a film with the screen printing apparatus so as to cover the heat-generating layer and the electrodes with part of each of the electrodes left uncovered, and the resultant was dried in a drying furnace at 200° C. for 1 hour so that the solvent component was removed. Thus, a protective layer having a thickness of 5 μm was formed. In order to secure electrode terminals, printing was performed so that the polyimide varnish was not applied to part of each of the electrodes (30 mm long). Next, the laminate obtained by laminating the heat-generating layer, the electrode layer, and the protective layer on the insulating resin base material was perforated with through-holes each having a diameter of 1 mm that were on concentric circles with the non-printed portions of the heat-generating layer through use of a pinnacle die (manufactured by Tsukatani Hamono Mfg. Co., Ltd.) to produce a planar heat-generating element. That is, the width of each of the portions free of the heat-generating layer was 0.5 mm. Finally, the end portion (portion where the protective layer was not laminated) of each of the electrodes was perforated with a through-hole having a diameter of 3 mm with a punching punch, an electric eyelet was mounted thereonto with a hand press machine, and an electric wire was connected at the eyelet portion through use of solder.

Cross-sectional observation of the produced planar heat-generating element was performed, and as a result, it was found that the thickness of the through-hole adjacent portion of the heat-generating layer was 16.5 μm, and the thickness of the other portion of the heat-generating layer was 15.0 μm.

Evaluation of the planar heat-generating element was performed as described below. The planar heat-generating element was mounted onto the bottom surface of a rectangular parallelepiped box made of SUS measuring 300 mm long by 350 mm wide by 200 mm high and having a plate thickness of 1 mm, and an air blower was mounted onto a side surface of the box. While air was blown, power was applied to the planar heat-generating element from an external power source to generate hot air. Thermocouples were placed at the through-hole neighboring portion of the surface of the planar heat-generating element and a portion other than the through-hole neighboring portion, and each surface temperature of the planar heat-generating element was measured. The temperature of air was measured with a thermocouple at a position 20 mm below the through-hole under a state in which power was applied to the planar heat-generating element from the external power source while air was blown.

The planar heat-generating element surface temperature of the through-hole neighboring portion of the planar heat-generating element of Example 1A and the planar heat-generating element surface temperature of the other portion, and the temperature of air were measured. When air was blown at an air speed of 1.5 m/s with the air blower, and a power of 1.0 W/cm² was applied from the external power source, the results were as follows: the temperature of the through-hole neighboring portion of the planar heat-generating element was 118° C., the temperature of the portion other than the through-hole neighboring portion was 102° C., and the temperature of air was 81° C.

### Example 2A

The heat-generating layer conductive material used in this Example is the same as that of Example 1A. The method of producing the planar heat-generating element is also mostly the same as that of Example 1A, but the printing speed was changed to 5.0 m/s. The positions and sizes of the non-printed portions and through-holes of the heat-generating layer are also the same as those of Example 1A. With regard to the thickness of the heat-generating layer, the thickness of the through-hole adjacent portion of the heat-generating layer was 17.2 μm, and the thickness of the other portion of the heat-generating layer was 15.0 μm.

When air was blown at an air speed of 1.5 m/s with the air blower, and a power of 1.0 W/cm² was applied from the external power source, the results were as follows: the surface temperature of the through-hole neighboring portion of the planar heat-generating element was 128° C., the surface temperature of the portion other than the through-hole neighboring portion was 98° C., and the temperature of air was 84° C.

### Example 3A

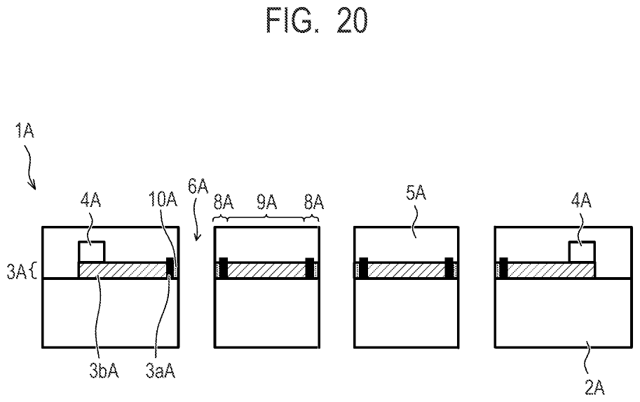

The heat-generating layer conductive material used in this Example is the same as that of Example 1A. The method of producing the planar heat-generating element is also mostly the same as that of Example 1A, but repeated application was performed on only the through-hole adjacent portion of the heat-generating layer through screen printing during the production. Specifically, the heat-generating layer conductive material was formed into a film on the protective layer base material through use of screen printing and the like, and the resultant was dried to form a heat-generating layer. Subsequently, the same heat-generating layer conductive material was formed into a film on the heat-generating layer through use of screen printing in such a manner as to be laminated on the heat-generating layer only at a portion adjacent to each through-hole, and the resultant was dried to form a through-hole adjacent portion. The positions and sizes of the non-printed portions and through-holes of the heat-generating layer are also the same as those of Example 1A. A schematic cross-sectional view of the planar heat-generating element in Example 3A is illustrated in FIG. 20. With regard to the thickness of the heat-generating layer 3A, the thickness of the through-hole adjacent portion 3aA of the heat-generating layer was 16.5 μm, and the thickness of the other portion 3bA was 15.0 μm. When air was blown at an air speed of 1.5 m/s with the air blower, and a power of 1.0 W/cm² was applied from the external power source, the results were as follows: the surface temperature of the through-hole neighboring portion of the planar heat-generating element was 119° C., the surface temperature of the portion other than the through-hole neighboring portion was 102° C., and the temperature of air was 81° C.

### Example 4A

The heat-generating layer conductive material used in this Example is the same as that of Example 1A. The method of producing the planar heat-generating element is also mostly the same as that of Example 3A, but the screen printing plate to be used for repeated application was changed so that the through-hole adjacent portion of the heat-generating layer was formed to be thicker than in Example 3A. The positions and sizes of the non-printed portions and through-holes of the heat-generating layer are also the same as those of Example 1A. With regard to the thickness of the heat-generating layer, the thickness of the through-hole adjacent portion was 17.2 μm, and the thickness of the other portion of the heat-generating layer was 15.0 μm. When air was blown at an air speed of 1.5 m/s with the air blower, and a power of 1.0 W/cm² was applied from the external power source, the results were as follows: the surface temperature of the through-hole neighboring portion of the planar heat-generating element was 127° C., the surface temperature of the portion other than the through-hole neighboring portion was 99° C., and the temperature of air was 84° C.

### Example 5A

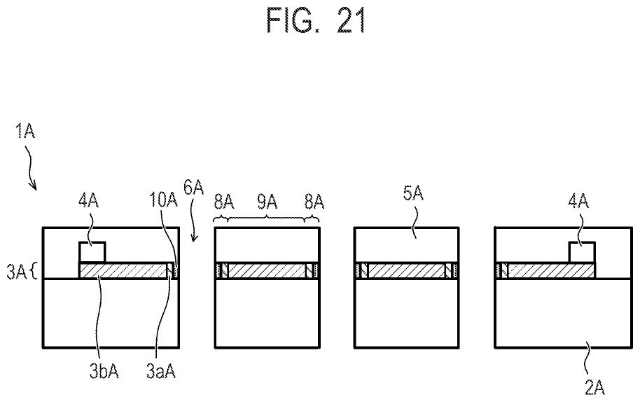

In this Example, a heat-generating layer conductive material having a lower volume resistivity than that in Example 1A was separately prepared as a heat-generating layer conductive material. The blending materials for the heat-generating layer conductive material having a lower volume resistivity than that in Example 1A are the same as those of Example 1A, but its volume resistivity was adjusted to 2.6×10⁻² Ω·cm by appropriately changing the blending amounts of the conductive powder 1 and the conductive powder 2. The method of producing the planar heat-generating element is also mostly the same as that of Example 1A, but only at a portion adjacent to each through-hole, the above-mentioned heat-generating layer conductive material having a lower volume resistivity was used and formed into a film by screen printing, followed by drying to form the through-hole adjacent portion 3aA. The positions and sizes of the non-printed portions and through-holes of the heat-generating layer are also the same as those of Example 1A. A schematic cross-sectional view of the planar heat-generating element in Example 3A is illustrated in FIG. 21. With regard to the thickness of the heat-generating layer 3A, the thickness of the through-hole adjacent portion 3aA of the heat-generating layer was 15.0 μm, and the thickness of the other portion 3bA was 15.0 μm. When air was blown at an air speed of 1.5 m/s with the air blower, and a power of 1.0 W/cm² was applied from the external power source, the results were as follows: the surface temperature of the through-hole neighboring portion of the planar heat-generating element was 119° C., the surface temperature of the portion other than the through-hole neighboring portion was 101° C., and the temperature of air was 81° C.

### Comparative Example 1A

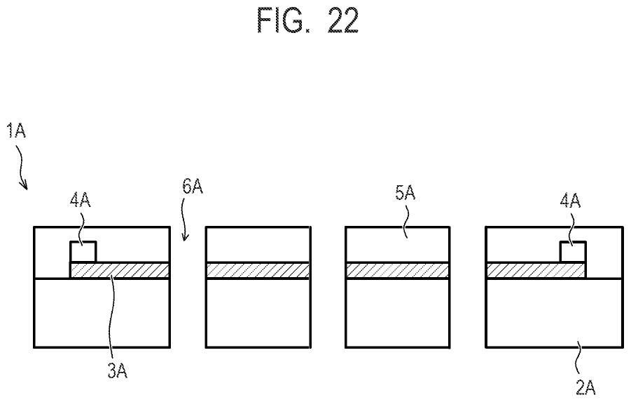

The heat-generating layer conductive material used in this Comparative Example is the same as that of Example 1A. The method of producing the planar heat-generating element is also mostly the same as that of Example 1A. However, the heat-generating layer was produced by solid printing without arranging the patterning of non-printed portions, the thickness of the through-hole adjacent portion of the heat-generating layer was 15.0 μm and the thickness of the other portion of the heat-generating layer was also 15.0 μm. A schematic cross-sectional view of the planar heat-generating element in Comparative Example 1A is illustrated in FIG. 22. When air was blown at an air speed of 1.5 m/s with the air blower, and a power of 1.0 W/cm² was applied from the external power source, the results were as follows: the surface temperature of the through-hole neighboring portion of the planar heat-generating element was 119° C., the surface temperature of the portion other than the through-hole neighboring portion was 101° C., and the temperature of air was 81° C.

TABLE 2

| | | | | | | | Compar- |
|---|---|---|---|---|---|---|---|
| | | | | | | | ative |
| | | Exam- | Exam- | Exam- | Exam- | Exam- | Exam- |
| | | ple 1A | ple 2A | ple 3A | ple 4A | ple 5A | ple 1A |
| Temperature | (° C.) | 118 | 128 | 119 | 127 | 119 | 110 |
| of through- | | | | | | | |
| hole | | | | | | | |
| neighboring | | | | | | | |
| portion | | | | | | | |
| Temperature | (° C.) | 102 | 98 | 102 | 99 | 101 | 110 |
| of portion | | | | | | | |
| other than | | | | | | | |
| through-hole | | | | | | | |
| neighboring | | | | | | | |
| portion | | | | | | | |
| Temperature | (° C.) | 16 | 30 | 17 | 28 | 18 | 0 |
| difference | | | | | | | |
| Temperature | (° C.) | 81 | 84 | 81 | 84 | 81 | 78 |
| of air | | | | | | | |

### [Third Embodiment]

In the method of Japanese Patent Application Laid-Open No. 2007-109640, on the surface of an insulating base layer, a heat-generating layer and an insulating protective layer are completely imidated by heating, and are then cooled, and hence a planar heat-generating element after the cooling is formed to be warped so that the protective layer may be on the inside. When an object to be heated is to be heated with the planar heat-generating element formed to be warped so that the protective layer may be on the inside as just described, the warping of the planar heat-generating element needs to be corrected so that the object to be heated may be uniformly heated. In this case, when the heat-generating layer and the insulating protective layer are completely imidated, the warping becomes so large that the warping cannot be successfully corrected in some cases. In addition, when the protective layer is completely imidated, the flexibility of the protective layer cannot be kept. When the planar heat-generating element is bonded to, for example, a metal flat plate with an adhesive or the like in order to hold the planar heat-generating element so that the object to be heated may be uniformly heated, the warping of the planar heat-generating element causes air to be entrapped between the metal flat plate and the planar heat-generating element, with the result that the entirety thereof cannot be uniformly bonded in some cases. This phenomenon leads to temperature unevenness of the object to be heated, possibly causing a reduction in quality or a defect. In addition, breakage of the planar heat-generating element itself or thermal deterioration of its material is sometimes induced at an excessive temperature increase portion of the temperature unevenness. In addition, a local temperature difference is produced in the planar heat-generating element to cause distortion thereof or peeling of a fixed portion, with the result that the object to be heated cannot be uniformly heated in some cases.

To solve the above-mentioned problem, the present invention provides a planar heat-generating element including: a base material; a heat-generating layer arranged on the base material; electrodes arranged to be brought into contact with the heat-generating layer; and a protective layer covering at least part of each of the electrodes and the heat-generating layer, wherein the base material and the protective layer are each formed of polyimide, and wherein the imidation ratio of the polyimide of the protective layer is smaller than the imidation ratio of the polyimide of the base material. The present invention also provides a hot air supply apparatus including the planar heat-generating element, and an inkjet printer including the hot air supply apparatus. The present invention also provides a method of manufacturing a planar heat-generating element including: a base material formed of polyimide; a heat-generating layer arranged on the base material; electrodes arranged to be brought into contact with the heat-generating layer; and a protective layer covering at least part of each of the electrodes and the heat-generating layer, the method including a step of imidating a precursor of the protective layer through heating in the range of from 150° C. or more to 300° C. or less to form the protective layer. Differences from the first embodiment and the second embodiment are mainly described below. (

### Configuration of Planar Heat-Generating Element)

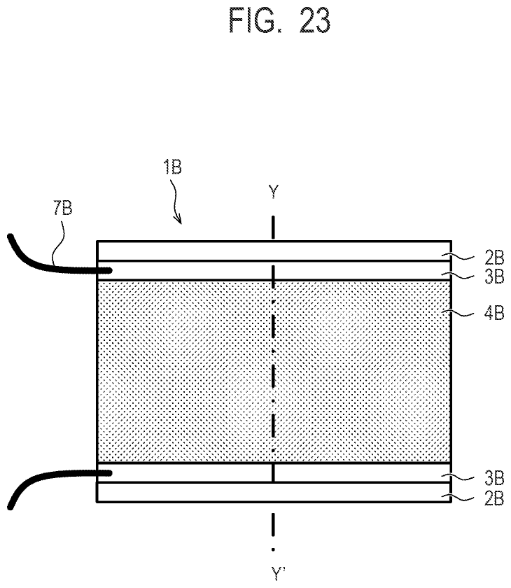

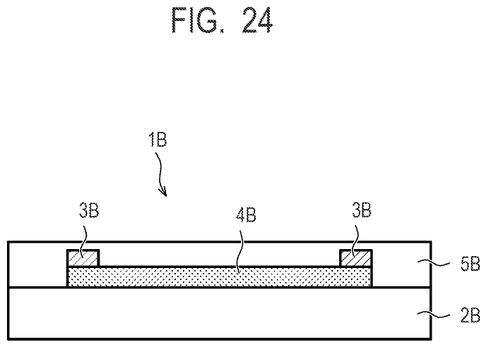

The configuration of a planar heat-generating element according to one embodiment of the present invention is described. FIG. 23 is a top schematic view of a planar heat-generating element 1B, and FIG. 24 is a cross-sectional schematic view taken along the line Y-Y′ of FIG. 23. It should be noted that, in FIG. 23, a protective layer 5B is omitted for the sake of description. On a base material 2B formed of polyimide, there is arranged a heat-generating layer 4B formed by forming a conductive paste containing conductive powder, a binder resin, and a solvent as components into a film through use of a bar coater, an applicator, screen printing, or the like, and drying the film. Electrodes 3B are arranged at edge portions on two opposed sides of the heat-generating layer 4B through use of a material having lower resistance than the heat-generating layer 4B, such as a paste or foil of silver or copper. Further, the protective layer 5B is arranged so as to cover the electrodes 3B and the heat-generating layer 4B, and to adhere to the base material 2B by applying and drying an insulating material formed of polyimide. Electric wires 7B for allowing a current to flow from an external power source are connected to the electrodes 3B.

Next, details about the properties of each layer of the planar heat-generating element and a manufacturing process thereof are described.

### (Polyimide)

The “polyimide” is a polymer having an imide structure in a repeating unit, the polymer being preferably obtained by imidating a polyimide precursor. As an example of the polyimide precursor, there is given a polymer compound obtained by subjecting an aromatic tetracarboxylic dianhydride and an aromatic diamine to dehydrative cyclization. In addition, a polyimide varnish may be used as the polyimide precursor, and the polyimide varnish is preferably a thermosetting one, which is excellent in heat resistance. Commercially available examples of the thermosetting polyimide varnish include: U-Varnish-A and U-Varnish-S manufactured by Ube Industries, Ltd., and U-Imide Varnish AR, U-Imide Varnish AH, U-Imide Varnish BH, U-Imide Varnish C, U-Imide Varnish CR, and U-Imide Varnish CH manufactured by Unitika Ltd. In addition, those thermosetting polyimide varnishes may be used alone or in combination thereof.

The polyimide precursor may contain a solvent, and the solvent is not particularly limited as long as the polyimide varnish dissolves therein. In particular, a high-boiling-point solvent, such as toluene, ethylene glycol, ethylene glycol monoether, or N-methyl-2-pyrrolidone (NMP), which hardly evaporates at the time of printing, is preferred. Those solvents may be used alone or in combination thereof.

In order for each layer to be formed to contain polyimide, required raw materials may be appropriately blended and mixed in addition to the polyimide precursor. A mixing method is not particularly limited, but examples thereof include a triple roll mill, a kneader, a planetary mixer, and a stirring machine.

Methods of forming the respective layers each containing polyimide are not particularly limited, but examples thereof include an applicator, a bar coater, screen printing, silk screen printing, gravure printing, flexographic printing, offset printing, and roll transfer printing. In particular, screen printing, silk screen printing, gravure printing, flexographic printing, offset printing, or roll transfer printing, which enables the formation of the layer in a desired pattern on the base material, is preferred.

The polyimide precursor is imidated. The imidation may be performed by heating the polyimide precursor (heating imidation). The heating imidation method is a method involving thermal dehydrative cyclization, and is performed by heating a thin film of the polyimide precursor to a temperature of 150° C. or more. First, as a first stage, the thin film is heated to 150° C. so that the solvent is evaporated. As a second stage, the resultant is heated to a temperature of 200° C. or more to undergo a dehydration reaction. Thus, a cyclic imide is produced.

### (Definition of Imidation Ratio)

The definition of an imidation ratio is described by using a case in which an aromatic tetracarboxylic dianhydride and an aromatic diamine are used as raw materials for producing the polyimide precursor. When the polyimide precursor is heated to be subjected to dehydrative cyclization, imidation proceeds through production of an imide group, but an aromatic ring does not change. When absorbances in an FT-IR spectrum of the polyimide resin after dehydrative cyclization by heating are taken, an imide group-derived peak appears around a wavenumber of 1,775 [cm⁻¹], and an aromatic ring-derived peak appears around a wavenumber of 1,519 [cm⁻¹]. A ratio between the imide group-derived absorbance and the aromatic ring-derived absorbance is defined as an imidation ratio λ1, a ratio between the imide group-derived absorbance and aromatic ring-derived absorbance of a completely imidated polyimide sheet is defined as an imidation ratio λ2, and μ1/λ2 is defined as the ratio of the imidation ratio to that of the base material. In Examples, a polyimide sheet was used as a completely imidated base material, and the result of the measurement of the λ2 of the base material was λ2=1.18.

### (Base Material)

It is preferred that the base material 2B be formed of polyimide and have an electrical insulating property. A sheet-shaped base material, a plate-shaped base material, or the like may be used as the base material 2B. An example of the sheet-shaped base material is a resin film formed of a polyimide resin. When formed of polyimide, the base material 2B has an electrical insulating property and heat resistance, and has incombustibility or flame retardancy.

### (Heat-Generating Layer)

The heat-generating layer 4B is preferably formed of polyimide and conductive powder. The heat-generating layer 4B may be formed by applying or printing a conductive paste into a sheet shape. The conductive paste contains conductive powder and a polyimide precursor.

The polyimide precursor is as described above. The conductive paste is produced by mixing (kneading) the above-mentioned blending materials with their blending ratio appropriately adjusted to achieve a desired volume resistivity and thickness of the film formed. A mixing method for the conductive paste is not particularly limited, but examples thereof include a triple roll mill, a kneader, a planetary mixer, and a stirring machine.

### (Protective Layer)

The thickness of the protective layer 5B is preferably 5 μm or more to 300 μm or less. The thickness of the protective layer is based on the thickness of the protective layer formed on the heat-generating layer.

Imidation may be performed by the above-mentioned heating imidation method. The heating imidation method is performed by heating a thin film of the polyimide precursor to a temperature of 150° C. or more. First, as a first stage, the thin film is heated to 150° C. and held thereat for 30 minutes so that the solvent is evaporated. Next, as a second stage, the resultant is heated to a temperature of 200° C. or more and held thereat for 1 hour to undergo a dehydration reaction. Thus, a cyclic imide is produced. From the viewpoint that the imidation ratio of the protective layer to be described later is not excessively high, the upper limit temperature in the heating imidation method for the protective layer is preferably 300° C. or less, and the temperature is more preferably 250° C. or less.

### (Heater Characteristics and Imidation Ratio)

As a configuration of the planar heat-generating element, the protective layer is arranged so as to prevent the heat-generating layer from being damaged by contact with the object to be heated or the like. In order for the protective layer to play its protective role, certain levels of strength, peeling resistance, and insulating property are required, and hence a minimum of imidation is required. The lower limit thereof is λ1/λ2=0.55.

When the imidation ratio of the protective layer is increased excessively, the warping becomes so large that the warping cannot be successfully corrected in some cases. In addition, when the planar heat-generating element is bonded to, for example, a metal flat plate with an adhesive or the like in order to hold the planar heat-generating element, the warping of the planar heat-generating element causes air to be entrapped between the metal flat plate and the planar heat-generating element, with the result that the entirety thereof cannot be uniformly bonded in some cases. Accordingly, the upper limit thereof is λ1/λ2=0.76. That is, the ratio of the imidation ratio of the polyimide of the protective layer to the imidation ratio of the polyimide of the base material is preferably 0.55 or more to 0.76 or less.

A preferred range of the imidation ratio of each layer is as described below. That is, the imidation ratio of the polyimide of the heat-generating layer is preferably 0.7 or more to 0.9 or less, the imidation ratio of the polyimide of the base material is preferably 1.1 or more to 1.5 or less, and the imidation ratio of the polyimide of the protective layer is preferably 0.5 or more to 0.9 or less.

(Relationship between Thicknesses of Base Material and Protective Layer)

As the protective layer becomes thinner, the influence of curing shrinkage due to imidation becomes smaller, and hence it is desired that the thickness of the protective layer be not larger than the thickness of the base material. The ratio of the thickness of the base material to the thickness of the protective layer is preferably 1 or more to 10 or less. When the ratio is more than 10, there is a risk in that a sufficient function as a protective layer such as an insulating property cannot be exhibited. In addition, the thickness of the protective layer is particularly desirably 75 μm or less because the warping is reduced, and is particularly desirably 15 μm or less because the warping can be easily corrected.

### (Warping of Planar Heat-Generating Element)

The warping of the planar heat-generating element is sometimes corrected so that the object to be heated may be uniformly heated. For example, the planar heat-generating element is sometimes bonded to a metal flat plate with an adhesive or the like so that the object to be heated may be uniformly heated. As can be seen from this, the warping is desirably as small as possible in order to uniformly heat the object to be heated. Specifically, the curvature of the surface of the protective layer is preferably 10×10⁻³ (1/mm) or less. A more preferred curvature of the surface of the protective layer is 8×10⁻³ (1/mm) or less. A still more preferred curvature of the surface of the protective layer is 4×10⁻³ (1/mm) or less.

### (Materials for Base Material, Heat-Generating Layer, and Protective Layer)

The base material, the heat-generating layer, and the protective layer are preferably formed of the same polyimide because the warping can be reduced by virtue of satisfactory adhesiveness and linear expansion coefficients equal to each other. In particular, the base material and the protective layer are preferably formed of the same polyimide. The “same polyimide” refers to polyimides obtained by using single precursors, preferably commercially available precursors, such as U-Varnish-A or U-Varnish-S manufactured by Ube Industries, Ltd., or U-Imide Varnish AR, U-Imide Varnish AH, U-Imide Varnish BH, U-Imide Varnish C, U-Imide Varnish CR, or U-Imide Varnish CH manufactured by Unitika Ltd., or by using a mixture of two or more kinds thereof in the same combination at the same ratio. Further, the “same polyimide” also encompasses a case of using single polyimides having the same structural formula but having different molecular weights, single polyimides having the same structural formula but having different viscosities, or single polyimides of different brands having the same structural formula.

Typical examples of the structural formula of the polyimide are described.

For example, U-Imide Varnish AR, U-Imide Varnish AH, and U-Varnish-S each include 3,3′,4,4′-biphenyltetracarboxylic dianhydride (BPDA) represented by the following formula (1) and p-phenylenediamine (1,4-phenylenediamine) (PDA) represented by the following formula (2).

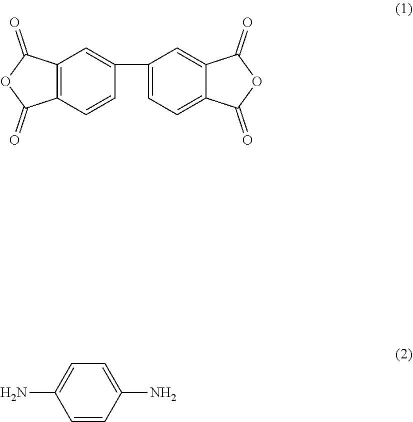 [SMILES: O=C1OC(=O)c2cc(-c3ccc4c(c3)C(=O)OC4=O)ccc21 ; Nc1ccc(N)cc1]

In this case, the polyimide has a structure represented by the following formula (3).

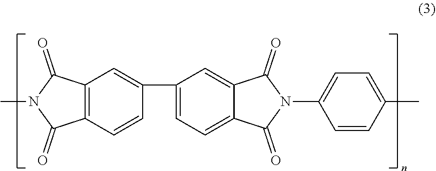

For example, raw materials for U-Varnish-A include BPDA represented by the formula (1) and 4,4′-oxydianiline (ODA (bis(4-aminophenyl) ether)) represented by the following formula (4).

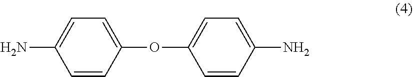 [SMILES: Nc1ccc(Oc2ccc(N)cc2)cc1]

In this case, the polyimide has a structure represented by the following

formula (5).

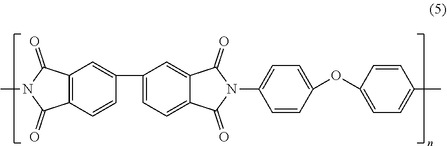

### (Relationship Among Imidation Ratios of Base Material, Heat-Generating Layer, and Protective Layer)

The curing shrinkage of an outermost surface makes the largest contribution to the warping, and hence the imidation ratios are preferably in the following order: base material>heat-generating layer≥protective layer. That is, the imidation ratio of the polyimide of the heat-generating layer is preferably smaller than the imidation ratio of the polyimide of the base material and equal to or larger than the imidation ratio of the polyimide of the protective layer.

### (Electrodes)

The electrodes 3B are to be connected to a power source so as to be able to energize the heat-generating layer 4B, and are formed by printing of a conductive ink or lamination and bonding of conductive foil. As the conductive ink, there is used, for example, an ink obtained by adding conductor powder formed of, for example, particles or scaly foil pieces of a metal or a metal oxide, such as copper, silver, ITO, or tin oxide, into a resin binder. Commercially available examples thereof include various pastes each containing silver or copper as a component, such as DD-1630L-245 and DD-3800-103 manufactured by Kyoto Elex Co., Ltd. In addition, for example, conductive foil formed of such metal or metal oxide as described above may be bonded and laminated.

### (Heat Generation of Planar Heat-Generating Element)

In order to cause the planar heat-generating element to generate heat, a current is caused to flow through the heat-generating layer so that heat may be generated through Joule heat. A power source for that purpose may be any of DC and AC power sources. In order to keep a constant amount of heat generated, a power source having its current or voltage stabilized is preferred. Further, a fuse or a circuit breaker is preferably mounted in order to prevent a short circuit and any other overcurrent.

### EXAMPLES

The present invention is specifically described below by way of Examples.

### Example 1B

### (Production of Conductive Paste)

In this Example, a conductive paste originally blended by the inventors was used. Blending materials and a mixing method are described below.

### Blending Materials

Conductive powder 1: carbon black
   KETJEN BLACK EC300J manufactured by Lion Specialty Chemicals Co., Ltd.
Conductive powder 2: graphite
   F#3 manufactured by Nippon Graphite Industries, Co., Ltd.
Binder resin: polyimide varnish
   U-Imide Varnish CR manufactured by Unitika Ltd.
Solvent: N-methyl-2-pyrrolidone (NMP)

The conductive paste was produced by sufficiently kneading the above-mentioned blending materials through use of a triple roll mill with their blending ratio appropriately adjusted to achieve a desired volume resistivity and thickness of the film formed.

### (Production of Planar Heat-Generating Element)

A polyimide film having a thickness of 75 μm (UPILEX-S manufactured by Ube Industries, Ltd.) was used as a base material. The conductive paste described above was printed thereon with a screen printing apparatus (MT-650TVC eXtream manufactured by Micro-tec Co., Ltd.), and the resultant was dried in a drying furnace at 150° C. for 1 hour so that the solvent component was removed. After that, dehydrative cyclization was performed in a drying furnace at 200° C. for 1 hour. Thus, a heat-generating layer having a thickness of 15 μm was formed. The dimensions of the heat-generating region are a rectangle measuring 250 mm long by 300 mm wide. Next, a silver paste (DD-1630L-245 manufactured by Kyoto Elex Co., Ltd.) was formed into a film of a strip shape having a width of 5 mm on each of two opposed sides of the heat-generating layer with the screen printing apparatus, and the resultant was dried in a drying furnace at 200° C. for 1 hour so that the solvent component was removed. Thus, a pair of electrodes each having a thickness of 20 μm was formed.

Further, a polyimide varnish (U-Imide Varnish CR manufactured by Unitika Ltd.) serving as a polyimide precursor was formed into a film with the screen printing apparatus so as to cover the heat-generating layer and the electrodes with part of each of the electrodes left uncovered, and the resultant was dried in a drying furnace at 150° C. for 1 hour so that the solvent component was removed. After that, dehydrative cyclization was performed in a drying furnace at 200° C. for 1 hour. Thus, a protective layer having a thickness of 15 μm was formed. Finally, the part of each of the electrodes that had been left uncovered was perforated with a through-hole having a diameter of 3 mm with a punching punch, an electric eyelet was mounted thereonto with a hand press machine, and an electric wire was connected at the eyelet portion through use of solder.

### (Measurement of Imidation Ratios)

In this Example, the imidation ratio λ1 of the heat-generating layer was 0.8, and the imidation ratio λ1 of the protective layer was 0.8. The ratio λ1/μ2 of the imidation ratio of the heat-generating layer to that of the base material was 0.68.

The ratio λ1/λ2 of the imidation ratio of the protective layer to that of the base material was 0.68.

The imidation ratio of the heat-generating layer was impossible to directly measure, and hence after evaluation of the magnitude of warping, adhesion fixing evaluation, and temperature unevenness evaluation had been completed, the protective layer was removed before absorbance measurement by Fourier transform infrared spectroscopy (FT-IR) was performed. Spotlight 400 manufactured by PerkinElmer, Inc. was used for FT-IR. The measurement was performed by an attenuated total reflection method (ATR method), the measurement with the spectroscope was performed in the range of from 4,000 (cm⁻¹) to 400 (cm⁻¹), and its resolution was 4 (cm⁻¹). Measurement data was obtained as a cumulative value of 4 scans. The measurement was performed at room temperature that was a temperature of 23° C.±2° C.

The protective layer was removed with a polishing apparatus (not shown) (manufactured by Maruto Instrument Co., Ltd., Doctor-Lap ML-180).

### (Evaluation of Magnitude of Warping)

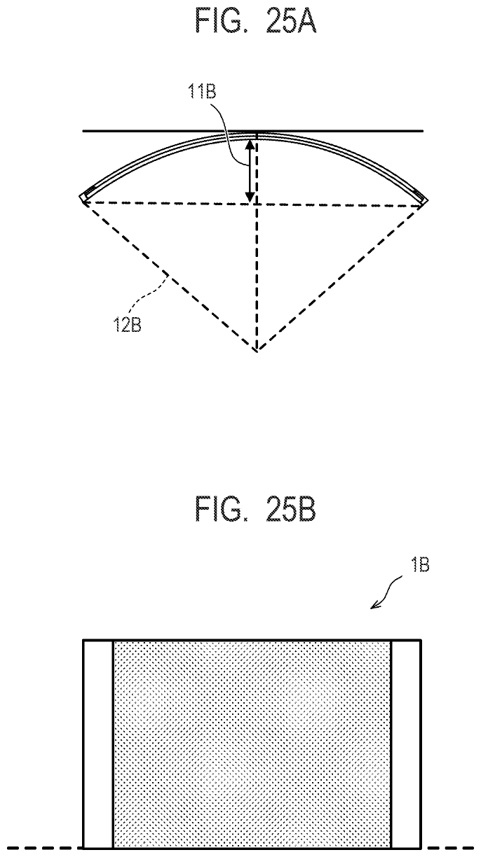

A method of evaluating the magnitude of warping is described below with reference to FIG. 25A and FIG. 25B.

The planar heat-generating element warps so that the protective layer may be on the inside after its production. An end portion of the planar heat-generating element in a right-angle direction with respect to the direction of the warping of the planar heat-generating element was placed on a horizontal surface. In this case, the maximum height of a space formed between the planar heat-generating element and the horizontal surface owing to the warping was defined as a magnitude 11B of the warping, a radius of curvature 12B was determined from the magnitude 11B of the warping, and the curvature was determined as follows: curvature=1/radius of curvature.

In this Example, the curvature was 1.28×10⁻³ (1/mm).

### (Adhesion Fixing Evaluation)

A method of evaluating an adhesion fixing state is described below. An adhesive was applied to the back surface of the planar heat-generating element of the present invention, that is, the non-laminated side of its base material in accordance with the positions of the holes of the heat-generating layer, and the resultant was subjected to adhesion fixing by being bonded to a plate made of SUS having a thickness of 0.5 mm. Visual observation is performed for lifting of the planar heat-generating element from the plate made of SUS or distortion thereof. A case in which the adhesion fixing state can be maintained without the occurrence of lifting or distortion is graded A, a case in which 1 to 5 sites of lifting or distortion are observed is graded B, a case in which 5 to 10 sites of lifting or distortion are observed is graded C, and a case in which 11 or more sites of lifting or distortion are observed is graded E. The adhesion fixing evaluation of this Example was B.

### (Temperature Unevenness Evaluation)

A method of evaluating temperature unevenness is described below. It was found that when a power of 0.5 W/cm² was applied to the planar heat-generating element of the present invention from an external power source, and the temperature distribution of a region of the heat-generating layer was measured with a thermoviewer, a portion of lifting or distortion of the planar heat-generating element locally had a high temperature. A difference between the highest temperature of the local high-temperature portion and the average temperature of other regions was calculated. A case in which the temperature difference is 10° C. or less is graded A, a case in which the temperature difference is more than 10° C. to 25° C. or less is graded B, a case in which the temperature difference is more than 25° C. to 40° C. or less is graded C, and a case in which the temperature difference is more than 40° C. is graded E. The temperature unevenness evaluation of this was B.

### Example 2B

The conductive paste used in this Example is the same as that of Example 1B. The method of producing the planar heat-generating element is also the same as that of Example 1B except that the thickness of the protective layer was changed to 7.5 μm.

In this Example, the imidation ratio λ1 of the heat-generating layer was 0.8, and the imidation ratio λ1 of the protective layer was 0.8. The ratio λ1/λ2 of the imidation ratio of the heat-generating layer to that of the base material was 0.68. The ratio λ1/λ2 of the imidation ratio of the protective layer to that of the base material was 0.68.

The curvature was 6.40×10⁻⁴ (1/mm).

The adhesion fixing evaluation was A, and the temperature unevenness evaluation was A.

### Example 3B

The conductive paste used in this Example is the same as that of Example 1B. The method of producing the planar heat-generating element is also the same as that of Example 1B except that the temperature at the time of the imidation of the heat-generating layer was changed to 250° C.

In this Example, the imidation ratio λ1 of the heat-generating layer was 0.85, and the imidation ratio λ1 of the protective layer was 0.8. The ratio λ1/λ2 of the imidation ratio of the heat-generating layer to that of the base material was 0.72.

The ratio λ1/λ2 of the imidation ratio of the protective layer to that of the base material was 0.68.

The curvature was 1.92×10⁻³ (1/mm).

The adhesion fixing evaluation was B, and the temperature unevenness evaluation was B.

### Example 4B

The conductive paste used in this Example is the same as that of Example 1B. The method of producing the planar heat-generating element is also the same as that of Example 1B except that the temperature at the time of the imidation of the protective layer was changed to 250° C.

In this Example, the imidation ratio λ1 of the heat-generating layer was 0.85, and the imidation ratio λ1 of the protective layer was 0.85. The ratio λ1/λ2 of the imidation ratio of the heat-generating layer to that of the base material was 0.72.

The ratio λ1/λ2 of the imidation ratio of the protective layer to that of the base material was 0.72.

The curvature was 2.58×10 −3 (1/mm).

The adhesion fixing evaluation was C, and the temperature unevenness evaluation was C.

### Example 5B

The conductive paste used in this Example is the same as that of Example 1B. The method of producing the planar heat-generating element is also the same as that of Example 1B except that the temperature at the time of the imidation of the heat-generating layer and the protective layer was changed to 250° C. and the thickness of the protective layer was changed to 75 μm.

In this Example, the imidation ratio μ1 of the heat-generating layer was 0.85, and the imidation ratio λ1 of the protective layer was 0.85. The ratio λ1/λ2 of the imidation ratio of the heat-generating layer to that of the base material was 0.72.

The ratio λ1/λ2 of the imidation ratio of the protective layer to that of the base material was 0.72.

The curvature was 3.92×10⁻³ (1/mm).

The adhesion fixing evaluation was C, and the temperature unevenness evaluation was C.

### Example 6B

The conductive paste used in this Example is the same as that of Example 1B. The method of producing the planar heat-generating element is also the same as that of Example 1B except that the temperature at the time of the imidation of the heat-generating layer and the protective layer was changed to 300° C.

In this Example, the imidation ratio λ1 of the heat-generating layer was 0.9, and the imidation ratio λ1 of the protective layer was 0.9. The ratio λ1/λ2 of the imidation ratio of the heat-generating layer to that of the base material was 0.76.

The ratio λ1/λ2 of the imidation ratio of the protective layer to that of the base material was 0.76.

The curvature was 9.33×10⁻³ (1/mm).

The adhesion fixing evaluation was C, and the temperature unevenness evaluation was C.

### Example 7B

The conductive paste used in this Example is the same as that of Example 1B. The method of producing the planar heat-generating element is also the same as that of Example 1B except that the temperature at the time of the imidation of the heat-generating layer and the protective layer was changed to 150° C.

In this Example, the imidation ratio λ1 of the heat-generating layer was 0.7, and the imidation ratio λ1 of the protective layer was 0.7. The ratio λ1/λ2 of the imidation ratio of the heat-generating layer to that of the base material was 0.55.

The curvature was 6.40×10⁻⁴ (1/mm).

The adhesion fixing evaluation was A, and the temperature unevenness evaluation was B.

### Example 8B

The conductive paste used in this Comparative Example is DY-150H-30 manufactured by Toyobo Co., Ltd.

This conductive paste contains a binder resin containing, as a main component, copolyester that is a thermoplastic resin, and contains carbon black and graphite as conductive powders. The method of producing the planar heat-generating element is the same as that of Example 1B.

In this Example, the imidation ratio λ1 of the protective layer was 0.8.

The ratio λ1/λ2 of the imidation ratio of the protective layer to that of the base material was 0.68.

The curvature was 1.02×10⁻³ (1/mm).

The adhesion fixing evaluation was B, and the temperature unevenness evaluation was C.

### Example 9B

The conductive paste used in this Comparative Example used a polyimide varnish (U-Imide Varnish AR manufactured by Unitika Ltd.) for the binder resin of the heat-generating layer.

The method of producing the planar heat-generating element is the same as that of Example 1B.

In this Example, the imidation ratio λ1 of the heat-generating layer was 0.8, and the imidation ratio λ1 of the protective layer was 0.8. The ratio λ1/λ2 of the imidation ratio of the heat-generating layer to that of the base material was 0.68.

The ratio λ1/λ2 of the imidation ratio of the protective layer to that of the base material was 0.68.

The curvature was 3.05×10⁻³ (1/mm).

The adhesion fixing evaluation was C, and the temperature unevenness evaluation was B.

### Comparative Example 1B

The conductive paste used in this Comparative Example is the same as that of Example 1B. The method of producing the planar heat-generating element is the same as that of Example 1B except that a polyamide-imide resin (VYLOMAX HR-16NN manufactured by Toyobo Co., Ltd.) was used for the protective layer.

In this Comparative Example, the imidation ratio λ1 of the heat-generating layer was 0.8. The ratio λ1/λ2 of the imidation ratio of the heat-generating layer to that of the base material was 0.68.

The curvature was 1.28×10⁻³ (1/mm).

The adhesion fixing evaluation was B, and the temperature unevenness evaluation was E because partial peeling between the heat-generating layer and the surface layer occurred at the time of heating, causing a temperature unevenness of 40° C. or more.

### Comparative Example 2B

The conductive paste used in this Comparative Example is the same as that of Example 1B. The method of producing the planar heat-generating element is as described below. The conductive paste described in Example 1B was printed on a polyimide film having a thickness of 75 μm (UPILEX-S manufactured by Ube Industries, Ltd.) with a screen printing apparatus to form a heat-generating layer. Next, the silver paste described in Example 1B was formed into a film of a strip shape having a width of 5 mm on each of two sides of the heat-generating layer with the screen printing apparatus to form a pair of electrodes each having a thickness of 20 μm. Next, another polyimide film having a thickness of 75 μm as described above was prepared, and was caused to cover and adhere to the heat-generating layer and the electrodes with part of each of the electrodes left uncovered to form a protective layer. Thereafter, the resultant was dried in a drying furnace at 150° C. for 1 hour so that the solvent component of the heat-generating layer was removed. After that, dehydrative cyclization was performed in a drying furnace at 200° C. for 1 hour to imidate the heat-generating layer having a thickness of 15 μm and to stick the protective layer. Finally, the part of each of the electrodes that had been left uncovered was perforated with a through-hole having a diameter of 3 mm with a punching punch, an electric eyelet was mounted thereonto with a hand press machine, and an electric wire was connected at the eyelet portion through use of solder.

In this Comparative Example, the imidation ratio λ1 of the heat-generating layer was 0.8, and the imidation ratio λ1 of the protective layer was 1.18. The ratio λ1/λ2 of the imidation ratio of the heat-generating layer to that of the base material was 0.68.

The ratio λ1/λ2 of the imidation ratio of the protective layer to that of the base material was 1.

The curvature was 1.05×10⁻² (1/mm).

The warping was impossible to sufficiently correct owing to the large warping and high stiffness of the protective layer, and hence the adhesion fixing evaluation was E, and the temperature unevenness evaluation was E.

Table 3 shows the firing temperature of the heat-generating layer, the firing temperature of the protective layer, the imidation ratio of the heat-generating layer, the ratio of the imidation ratio of the heat-generating layer to that of the base material, the ratio of the imidation ratio of the protective layer to that of the base material, the thickness of the base material, the thickness of the heat-generating layer, the thickness of the protective layer, the ratio between the thicknesses of the base material and the protective layer, the curvature, the material for the binder resin of the heat-generating layer, the material for the protective layer, and the results of the adhesion fixing evaluation and the temperature unevenness evaluation in each of Examples 1B to 9B, and Comparative Examples 1B and 2B.

TABLE 3

| | | | | | | Ratio of | | | |
|---|---|---|---|---|---|---|---|---|---|
| | | | | | | imidation | | | |
| | Firing | | | | | ratio to | | | |
| | temperature | Firing | | | Imidation | that of base | | | |
| | of heat- | temperature | Imidation | Imidation | ratio of | material | | Thickness | Thickness |
| | generating | of protective | ratio | ratio of | heat- | | Heat- | of base | of protective |
| | layer | layer | of base | protective | generating | Protective | generating | material | layer |
| | (° C.) | (° C.) | material | layer | layer | layer | layer | (μm) | (μm) |
| Exam- | 200 | 200 | 1.18 | 0.8 | 0.8 | 0.68 | 0.68 | 75 | 15 |
| ple 1B | | | | | | | | | |
| Exam- | 200 | 200 | 1.18 | 0.8 | 0.8 | 0.68 | 0.68 | 75 | 7.5 |
| ple 2B | | | | | | | | | |
| Exam- | 250 | 200 | 1.18 | 0.8 | 0.85 | 0.68 | 0.72 | 75 | 15 |
| ple 3B | | | | | | | | | |
| Exam- | 200 | 250 | 1.18 | 0.85 | 0.85 | 0.72 | 0.72 | 75 | 15 |
| ple 4B | | | | | | | | | |
| Exam- | 250 | 250 | 1.18 | 0.85 | 0.85 | 0.72 | 0.72 | 75 | 75 |
| ple 5B | | | | | | | | | |
| Exam- | 300 | 300 | 1.18 | 0.9 | 0.9 | 0.76 | 0.76 | 75 | 15 |
| ple 6B | | | | | | | | | |
| Exam- | 150 | 150 | 1.18 | 0.7 | 0.7 | 0.55 | 0.55 | 75 | 15 |
| ple 7B | | | | | | | | | |
| Exam- | 200 | 200 | 1.18 | 0.8 | — | 0.68 | — | 75 | 15 |
| ple 8B | | | | | | | | | |
| Exam- | 200 | 200 | 1.18 | 0.8 | 0.8 | 0.68 | 0.68 | 75 | 15 |
| ple 9B | | | | | | | | | |
| Compar- | 200 | 200 | 1.18 | — | 0.8 | — | 0.68 | 75 | 15 |
| ative | | | | | | | | | |
| Exam- | | | | | | | | | |
| ple 1B | | | | | | | | | |
| Compar- | 200 | 200 | 1.18 | 1.18 | 0.8 | 1 | 0.68 | 75 | 75 |
| ative | | | | | | | | | |
| Exam- | | | | | | | | | |
| ple 2B | | | | | | | | | |

| | | Ratio | | | | | |
|---|---|---|---|---|---|---|---|
| | | between | | Material | | | |
| | Thickness | thicknesses | | for binder | | | |
| | of heat- | of base | | resin of | | | |
| | generating | material and | | heat- | Material for | Evaluation | |
| | layer | protective | Curvature | generating | protective | Adhesion | Temperature |
| | (μm) | layer | (1/mm) | layer | layer | fixing | unevenness |
| Exam- | 15 | 5 | 1.28 × | Unitika | Unitika | B | B |
| ple 1B | | | 10⁻³ | CR | CR | | |
| Exam- | 15 | 10 | 6.40 × | Unitika | Unitika | A | A |
| ple 2B | | | 10⁻⁴ | CR | CR | | |
| Exam- | 15 | 5 | 1.92 × | Unitika | Unitika | B | B |
| ple 3B | | | 10⁻³ | CR | CR | | |
| Exam- | 15 | 5 | 2.58 × | Unitika | Unitika | C | C |
| ple 4B | | | 10⁻³ | CR | CR | | |
| Exam- | 15 | 1 | 3.92 × | Unitika | Unitika | C | C |
| ple 5B | | | 10⁻³ | CR | CR | | |
| Exam- | 15 | 5 | 9.33 × | Unitika | Unitika | C | C |
| ple 6B | | | 10⁻³ | CR | CR | | |
| Exam- | 15 | 5 | 6.40 × | Unitika | Unitika | A | B |
| ple 7B | | | 10⁻⁴ | CR | CR | | |
| Exam- | 15 | 5 | 1.02 × | Copolyester | Unitika | B | C |
| ple 8B | | | 10⁻³ | | CR | | |
| Exam- | 15 | 5 | 3.05 × | Unitika | Unitika | C | B |
| ple 9B | | | 10⁻³ | AR | CR | | |
| Compar- | 15 | 5 | 1.28 × | Unitika | PAI | B | E |
| ative | | | 10⁻³ | CR | | | |
| Exam- | | | | | | | |
| ple 1B | | | | | | | |
| Compar- | 15 | 1 | 1.05 × | Unitika | UPILEX-S | E | E |
| ative | | | 10⁻² | CR | | | |
| Exam- | | | | | | | |
| ple 2B | | | | | | | |

According to the present invention, the planar heat-generating element having reduced temperature unevenness in the plane of its heating surface can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-158808 filed Sep. 30, 2022, Japanese Patent Application No. 2022-158806 filed Sep. 30, 2022, and Japanese Patent Application No. 2022-164898 filed Oct. 13, 2022, which are hereby incorporated by reference herein in their entirety.

What is claimed is:

1. A planar heat-generating element comprising:
a base material;
a heat-generating layer formed on the base material, the heat-generating layer having conductivity;
a pair of electrodes arranged to be brought into contact with the heat-generating layer; and
a protective layer covering at least part of each of the pair of electrodes and the heat-generating layer,
wherein the pair of electrodes are arranged so as to be opposed to each other in a direction parallel to a first direction,
wherein the heat-generating layer has a plurality of holes in a region between the pair of electrodes,
wherein the base material and the protective layer each have holes to be connected to the holes of the heat-generating layer at positions corresponding to the holes of the heat-generating layer, and
wherein, when widths of two holes out of the plurality of holes in a second direction orthogonal to the first direction, the two holes being present adjacent to each other on one and the same straight line parallel to the second direction, are represented by a1 and a2, respectively, and an interval between the two holes in a direction parallel to the second direction is represented by D,
the D, the a1, and the a2 satisfy a relationship represented by the following expression (1).
2×(a1+a2)/2<D<10×(a1+a2)/2 (1).

2. The planar heat-generating element according to claim 1, wherein the planar heat-generating element is configured such that a current flowing between the pair of electrodes when a voltage is applied between the pair of electrodes flows while having a component in a direction parallel to the first direction across an entire region of the heat-generating layer present between the pair of electrodes.

3. The planar heat-generating element according to claim 1, wherein a ratio of a sum total of opening areas of the holes to an area of the heat-generating layer falls within a range of from 1.2% or more to 15% or less.

4. The planar heat-generating element according to claim 1, wherein mutually connected holes of the base material, the heat-generating layer, and the protective layer have cross-sectional shapes identical to each other in directions perpendicular to a lamination direction of the base material, the heat-generating layer, and the protective layer.

5. The planar heat-generating element according to claim 1, wherein, when a ratio of a width of each of the holes of the heat-generating layer in the first direction to a width thereof in the second direction is represented by b/a, the b/a is 1 or more.

6. The planar heat-generating element according to claim 5, wherein an opening shape of each of the holes of the heat-generating layer is an ellipse.

7. The planar heat-generating element according to claim 1, wherein the holes of the heat-generating layer are arranged in a staggered shape as seen from a direction parallel to a lamination direction of the base material and the heat-generating layer.

8. A hot air supply apparatus comprising:
the planar heat-generating element of claim 1; and
an air blower configured to generate an air flow.

9. A planar heat-generating element comprising:
a base material;
a heat-generating layer arranged on the base material;
electrodes to be brought into contact with the heat-generating layer; and
a protective layer covering the electrodes and the heat-generating layer,
the planar heat-generating element having one or more through-holes penetrating through the base material, the heat-generating layer, and the protective layer,
wherein a through-hole adjacent portion of the heat-generating layer is thicker, or has a lower volume resistivity, than another portion of the heat-generating layer.

10. The planar heat-generating element according to claim 9, wherein a thickness (T1 [μm]) of the through-hole adjacent portion of the heat-generating layer and a thickness (T2 [μm]) of the another portion of the heat-generating layer satisfy 1<T1/T2≤1.2.

11. The planar heat-generating element according to claim 9, wherein, when a power of 1.0 W/cm 2 is applied to the electrodes, a temperature (Y [° C.]) of a through-hole neighboring portion of a surface of the planar heat-generating element and a temperature (X [° C.]) of a portion of the surface other than the through-hole neighboring portion satisfy 0<Y−X≤30.

12. The planar heat-generating element according to claim 9, wherein the planar heat-generating element has a portion free of the heat-generating layer in a vicinity of each of the one or more through-holes.

13. A hot air supply apparatus comprising:
the planar heat-generating element of claim 9; and
an air blower configured to cause air to flow through the one or more through-holes.

14. A planar heat-generating element comprising:
a base material;
a heat-generating layer arranged on the base material;
electrodes arranged to be brought into contact with the heat-generating layer; and
a protective layer covering at least part of each of the electrodes and the heat-generating layer,
wherein the base material and the protective layer are each formed of polyimide, and
wherein an imidation ratio of the polyimide of the protective layer is smaller than an imidation ratio of the polyimide of the base material.

15. The planar heat-generating element according to claim 14, wherein a ratio of the imidation ratio of the polyimide of the protective layer to the imidation ratio of the polyimide of the base material is 0.55 or more to 0.76 or less.

16. The planar heat-generating element according to claim 14, wherein a ratio of a thickness of the base material to a thickness of the protective layer is 1 or more to 10 or less.

17. The planar heat-generating element according to claim 14, wherein the base material and the protective layer are formed of the same polyimide.

18. The planar heat-generating element according to claim 14, wherein the base material, the heat-generating layer, and the protective layer are formed of the same polyimide.

19. The planar heat-generating element according to claim 14,
wherein the heat-generating layer contains polyimide, and
wherein an imidation ratio of the polyimide of the heat-generating layer is smaller than the imidation ratio of the polyimide of the base material, and is equal to or larger than the imidation ratio of the polyimide of the protective layer.

20. The planar heat-generating element according to claim 19, wherein the imidation ratio of the polyimide of the heat-generating layer is 0.7 or more to 0.9 or less.
